(19) United States
(12) Patent Application Publication
(10) Pub. No.: US 2014/0225904 A1
(43) Pub. Date: Aug. 14, 2014

(54) SHUTTER ASSEMBLIES FABRICATED ON MULTI-HEIGHT MOLDS

(71) Applicant: PIXTRONIX, INC., San Diego, CA (US)

(72) Inventors: Mark B. Andersson, Northborough, MA (US); Timothy J. Brosnihan, Natick, MA (US); Javier Villarreal, Somerville, MA (US); Joyce Wu, Somerville, MA (US)

(73) Assignee: PIXTRONIX, INC., San Diego, CA (US)

(21) Appl. No.: 13/766,475

(22) Filed: Feb. 13, 2013

(51) Int. Cl. G02F 1/01

(52) U.S. Cl. CPC G02F 1/0128; G02F 1/0102
USPC 345/501; 359/230; 445/24

(57) ABSTRACT

This disclosure provides systems, methods and apparatus for forming display structures having shutters that have a different height than corresponding actuators. In one aspect, a display apparatus includes an electrostatic actuator including opposing beam electrodes having primary faces normal to a substrate on which they are formed. The height of at least one of the opposing beam electrodes defines an actuator height. The apparatus also includes a shutter configured to be driven by the electrostatic actuator. The shutter includes at least one protrusion, the protrusion having a first sidewall and a second sidewall normal to a primary plane of the shutter, wherein a first sidewall height of the first sidewall is substantially different from the actuator height.

### TECHNICAL FIELD

This disclosure relates to displays, and in particular, to shutter assemblies for displays.

### DESCRIPTION OF THE RELATED TECHNOLOGY

Prior methods of creating shutters and electrostatic actuators for use in displays have involved the use of two sacrificial mold layers. A first layer was patterned to serve as a mold for the base of an anchor that supported the shutter over a substrate. The second mold layer was patterned to serve as a mold for the actuators and the shutter. By only using two mold layers, certain design limitations were imposed that compromised the true design potential of each of the shutter and the actuator.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display apparatus that includes an electrostatic actuator including opposing beam electrodes having primary faces normal to a substrate on which they are formed. The height of at least one of the opposing beam electrodes defines an actuator height. The apparatus also includes an electromechanical system (EMS) shutter configured to be driven by the electrostatic actuator, the shutter including at least one protrusion, the protrusion having a first sidewall and a second sidewall normal to a primary plane of the shutter, wherein a distal end of the actuator extends beyond a distal end of the first sidewall relative to the substrate. In some implementations, an actuator height of the actuator is substantially similar to a second sidewall height of the second sidewall. In some implementations, an actuator height of the actuator is substantially larger than a first sidewall height of the first sidewall and a second sidewall height of the second sidewall.

In some implementations, the protrusion includes a first distal surface parallel to the primary plane that is adjacent to a first sidewall and a second distal surface parallel to the primary plane adjacent to a second sidewall, wherein a height of the first sidewall is substantially different from a corresponding height of the second sidewall. In some implementations, the protrusion includes a distal surface parallel to the primary plane. The actuator has a proximal end aligned with the distal surface. In some implementations, the primary plane is aligned with the distal end of the actuator. In some implementations, the opposing beam electrodes includes a drive electrode and a load electrode, the load electrode having a height substantially smaller than the drive electrode.

In some implementations, the apparatus includes a display, a processor that is configured to process image data and a memory device that is configured to communicate with the processor. In some implementations, the apparatus includes a driver circuit configured to send at least one signal to the display and the processor is further configured to send at least a portion of the image data to the driver circuit. In some implementations, the apparatus includes an image source module configured to send the image data to the processor. In some such implementations, the image source module includes at least one of a receiver, transceiver, and transmitter. In some implementations, the apparatus includes an input device configured to receive input data and to communicate the input data to the processor.

Another innovative aspect of the subject matter described in this disclosure can be implemented in a method of fabricating a display structure. A first mold layer is deposited over a substrate and patterned. A second mold layer is then deposited over the patterned first mold layer. The deposited second mold layer is patterned to form anchors openings corresponding to where anchors will eventually be formed. A third mold layer is deposited over the patterned second mold layer. The deposited third mold layer is patterned to form protrusion openings corresponding to where a protrusion of a shutter of the display structure will eventually be formed and to form actuator openings corresponding to where actuator beams of an actuator of the display structure will eventually be formed. Electrically conductive material is deposited over the patterned third mold layer. The electrically conductive material is patterned to form the actuator and the shutter having the protrusion, the actuator having a height that is substantially different from a height of one of the sidewalls of the protrusion. In some implementations, the display structure including the actuator and the shutter is released.

In some implementations, the deposited third mold layer is patterned to form actuator openings that extend to a top surface of the first mold layer. In some implementations, the deposited third mold layer is patterned to form a protrusion opening that extends to a top surface of the second mold layer. In some implementations, the deposited third mold layer is patterned to form a protrusion opening that extends to a top surface of the second mold layer and to a top surface of the first mold layer such that a bottom of the opening is defined by both the first mold layer and the second mold layer. In some implementations, the deposited third mold layer is patterned to form actuator openings that extend to a top surface of the second mold layer. In some implementations, the deposited third mold layer is patterned to form a protrusion opening that extends to a top surface of the first mold layer.

Details of one or more implementations of the subject matter described in this specification are set forth in the accompanying drawings and the description below. Although the examples provided in this summary are primarily described in terms of EMS-based displays, the concepts provided herein may apply to other types of displays, such as liquid crystal displays (LCDs), organic light emitting diode (OLED) displays, electrophoretic displays, and field emission displays, as well as to other non-display EMS devices, such as EMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example schematic diagram of a direct-view microelectromechanical system (MEMS)-based display apparatus.

FIG. 1B shows an example block diagram of a host device.

FIG. 2 shows an example perspective view of an illustrative shutter-based light modulator.

FIG. 3A shows an example schematic diagram of a control matrix.

FIG. 3B shows an example perspective view of an array of shutter-based light modulators connected to the control matrix of FIG. 3A.

FIG. 4A and FIG. 4B show examples views of a dual actuator shutter assembly.

FIG. 5 shows an example cross sectional view of a display apparatus incorporating shutter-based light modulators.

FIGS. 6A-6E show cross sectional views of stages of construction of an example composite shutter assembly.

FIGS. 7A-7D show isomeric views of stages of construction of an example shutter assembly with narrow sidewall beams.

FIG. 8 shows a cross-sectional view of a portion of an example electromechanical systems (EMS) shutter-based display apparatus

FIG. 9 shows a flow diagram of an example manufacturing process of a display apparatus incorporating shutter assemblies including shutters having protrusions that have a depth substantially different from the height of corresponding electrostatic actuators.

FIGS. 10A-10F show stages of construction of an example display apparatus.

FIGS. 11A-11D show stages of construction of an example display apparatus.

FIG. 12A shows a cross-sectional view of a portion of another example EMS shutter-based display apparatus

FIG. 12B shows the example display apparatus shown in FIG. 12A prior to being released from a corresponding mold.

FIG. 13A shows a cross-sectional view of a portion of another example EMS shutter-based display apparatus.

FIG. 13B shows the example display apparatus shown in FIG. 13A prior to being released from a corresponding mold.

FIG. 14A shows a cross-sectional view of a portion of another example EMS shutter-based display apparatus.

FIG. 14B shows the example display apparatus shown in FIG. 14A prior to being released from a corresponding mold.

FIG. 15A shows a cross-sectional view of a portion of another example EMS shutter-based display apparatus.

FIG. 15B shows the example display apparatus shown in FIG. 14A prior to being released from a corresponding mold.

FIGS. 16A and 16B are example system block diagrams illustrating a display device that includes a set of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Shutter assemblies for use as light modulators in display apparatus can be fabricated to include electrostatic actuators that have substantially different heights than the sidewalls included in the shutters which they move. In some implementations, the actuators are taller than the shutter protrusions. In some other implementations, the actuators are shorter than the shutter protrusions. In some other implementations, the actuators are taller than a portion of the shutter protrusions, but have the same height as another portion of the protrusion. These variable heights of actuators and/or shutters can be achieved by introducing a third mold layer into the fabrication of the shutter assemblies.

Particular implementations of the subject matter described in this disclosure can be implemented to realize one or more of the following potential advantages. In particular, shutters that include deeper shutter protrusions can provide improved light blocking capabilities as light entering the protrusion can rebound off multiple surfaces before exiting the protrusion.

Shutters that include shallower shutter protrusions have their own advantages. Such shutters are less likely to touch down on a display substrate and possibly adhering thereto as a result of stiction. Thus, such shutters may prove more reliable than shutters with deeper protrusions. Moreover, shutters with shallower protrusions may be more streamlined, and thus may switch states faster. Furthermore, by increasing the distance between the shutter and a corresponding substrate on which circuitry for controlling the shutter is built, parasitic capacitance is reduced, thereby reducing power consumption and further improving display switching times.

In some implementations, the height of the actuators can also be increased. In doing so, the electrodes that form the actuators can exert a greater force on one another due to the increased surface area, thereby increasing the speed of the shutter.

In some implementations, actuator electrodes can include notches along their length. The notches provide additional compliance and reduce squeeze film damping between the load electrode and the opposing drive electrode of an actuator. As a result, the shutters can travel faster.

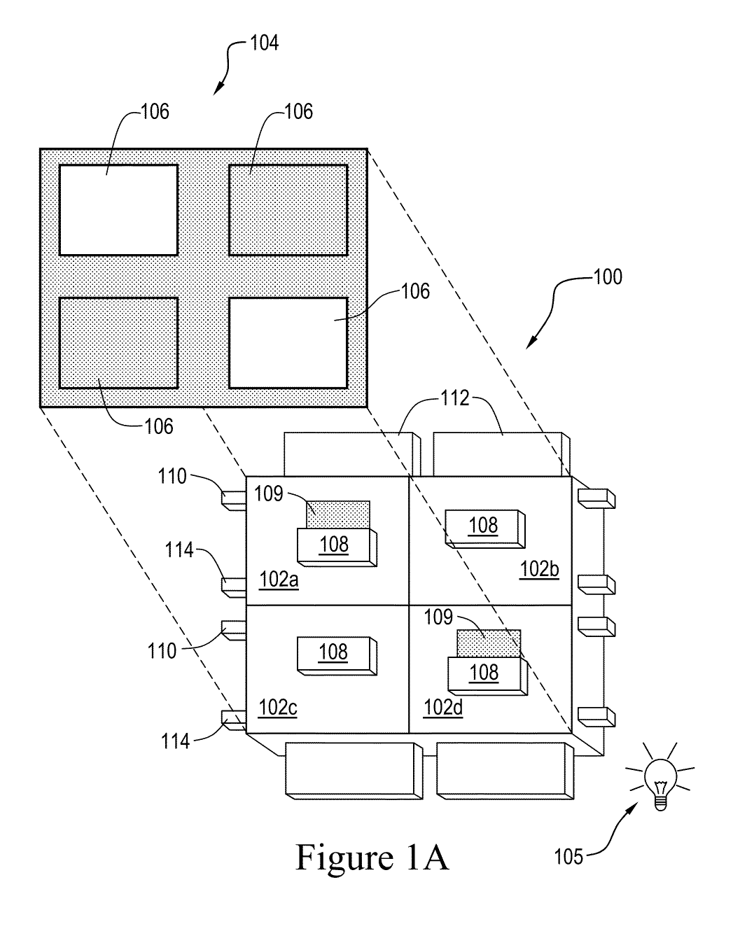

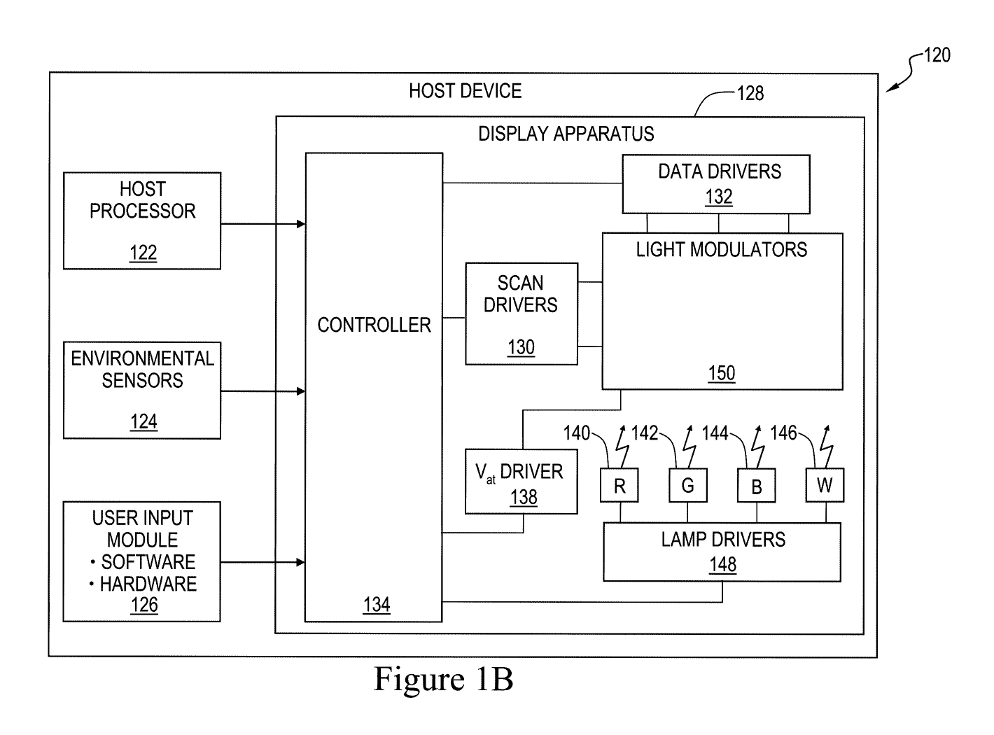

FIG. 1A shows a schematic diagram of a direct-view microelectromechanical system (MEMS)-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (e.g., interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows an example of a block diagram 120 of a host device (i.e., cell phone, smart phone, PDA, MP3 player, tablet, e-reader, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, and lamp drivers 148. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the light modulators, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all light modulators within the array of light modulators, for instance by supplying voltage to a series of common interconnects 114. In some other implementations, the common drivers 138, following commands from the controller 134, issue voltage pulses or signals to the array of light modulators, for instance global actuation pulses which are capable of driving and/or initiating simultaneous actuation of all light modulators in multiple rows and columns of the array.

All of the drivers (e.g., scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array of pixels, the output of voltages from the data drivers 132, and the output of voltages that provide for light modulator actuation.

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array is synchronized with the illumination of the lamps 140, 142, 144 and 146 such that alternate image frames are illuminated with an alternating series of colors, such as red, green and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the modulator array by a sequential addressing of individual rows, also referred to as scan lines. For each row or scan line in the sequence, the scan driver 130 applies a write-enable voltage to the write enable interconnect 110 for that row of the array, and subsequently the data driver 132 supplies data voltages, corresponding to desired shutter states, for each column in the selected row. This process repeats until data has been loaded for all rows in the array. In some implementations, the sequence of selected rows for data loading is linear, proceeding from top to bottom in the array. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array, for instance by addressing only every 5^{th} row of the array in sequence.

In some implementations, the process for loading image data to the array is separated in time from the process of actuating the shutters 108. In these implementations, the modulator array may include data memory elements for each pixel in the array, and the control matrix may include a global actuation interconnect for carrying trigger signals, from common driver 138, to initiate simultaneous actuation of shutters 108 according to data stored in the memory elements.

In alternative implementations, the array of pixels and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller 134 to provide data to the various drivers 130, 132, 138 and 148 which correspond to optimal imaging characteristics.

An environmental sensor module 124 also can be included as part of the host device. The environmental sensor module 124 receives data about the ambient environment, such as temperature and/or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

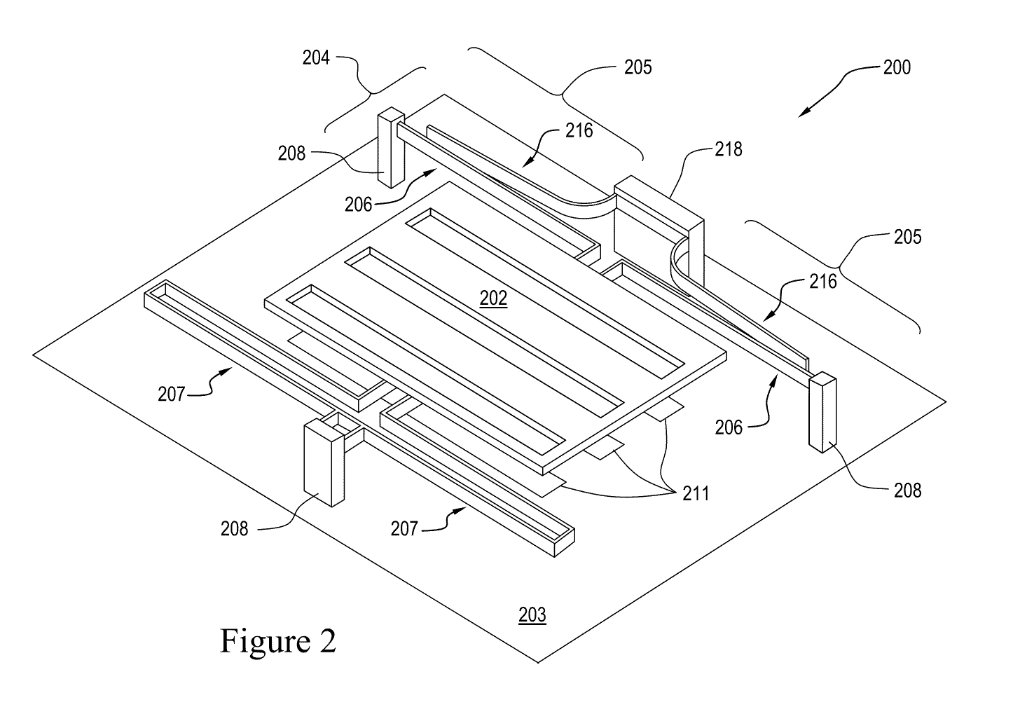

FIG. 2 shows a perspective view of an illustrative shutter-based light modulator 200. The shutter-based light modulator 200 is suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators 205”). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface 203 includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate. If the substrate is transparent, such as glass or plastic, then the aperture holes 211 are formed in a layer of light-blocking material deposited on the substrate. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely toward the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as the light modulator 200, incorporates a passive restoring force, such as a spring, for returning a shutter to its rest position after voltages have been removed. Other shutter assemblies can incorporate a dual set of “open” and “closed” actuators and separate sets of “open” and “closed” electrodes for moving the shutter into either an open or a closed state.

There are a variety of methods by which an array of shutters and apertures can be controlled via a control matrix to produce images, in many cases moving images, with appropriate luminance levels. In some cases, control is accomplished by means of a passive matrix array of row and column interconnects connected to driver circuits on the periphery of the display. In other cases, it is appropriate to include switching and/or data storage elements within each pixel of the array (the so-called active matrix) to improve the speed, the luminance level and/or the power dissipation performance of the display.

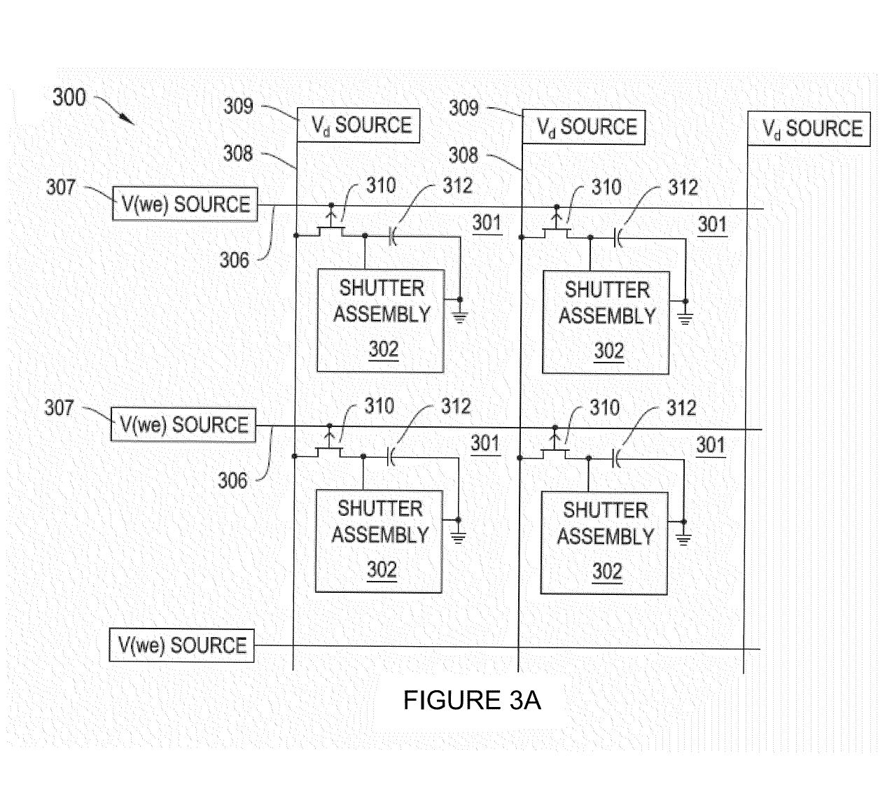

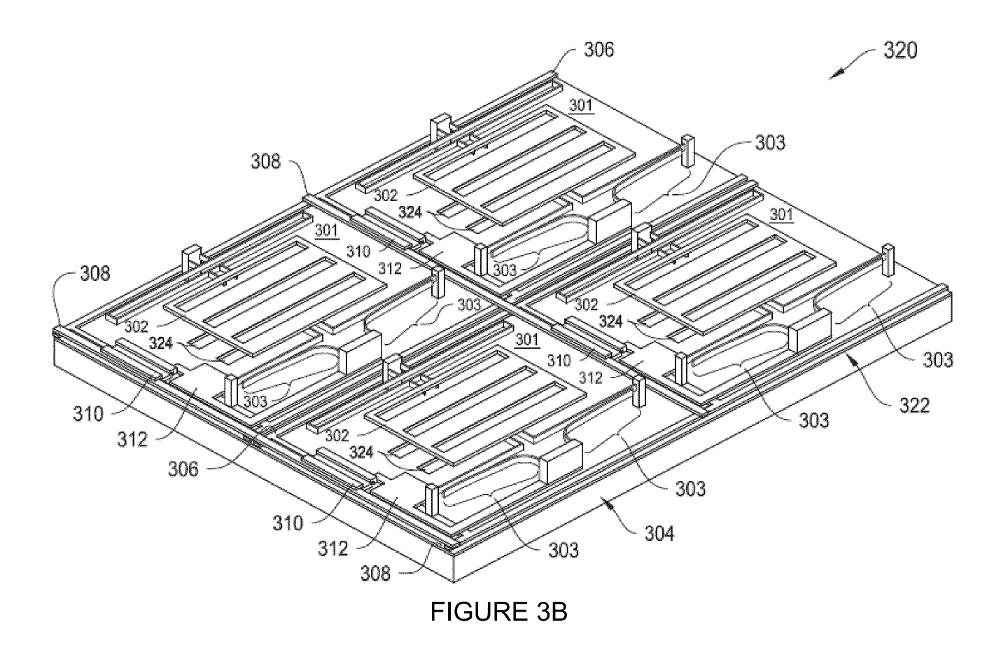

FIG. 3A shows an example schematic diagram of a control matrix 300. The control matrix 300 is suitable for controlling the light modulators incorporated into the MEMS-based display apparatus 100 of FIG. 1A. FIG. 3B shows a perspective view of an array 320 of shutter-based light modulators connected to the control matrix 300 of FIG. 3A. The control matrix 300 may address an array of pixels 320 (the “array 320”). Each pixel 301 can include an elastic shutter assembly 302, such as the shutter assembly 200 of FIG. 2, controlled by an actuator 303. Each pixel also can include an aperture layer 322 that includes apertures 324.

The control matrix 300 is fabricated as a diffused or thin-film-deposited electrical circuit on the surface of a substrate 304 on which the shutter assemblies 302 are formed. The control matrix 300 includes a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source 309 (“V_{d} source”) to the pixels 301 in a corresponding column of pixels. In the control matrix 300, the V_{d} source 309 provides the majority of the energy to be used for actuation of the shutter assemblies 302. Thus, the data voltage source, V_{d} source 309, also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V, to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly actuates, opening the shutter in that shutter assembly 302. The voltage applied to the data interconnect 308 remains stored in the capacitor 312 of the pixel 301 even after the control matrix 300 ceases to apply V_{we} to a row. Therefore, the voltage V, does not have to wait and hold on a row for times long enough for the shutter assembly 302 to actuate; such actuation can proceed after the write-enabling voltage has been removed from the row. The capacitors 312 also function as memory elements within the array 320, storing actuation instructions for the illumination of an image frame.

The pixels 301 as well as the control matrix 300 of the array 320 are formed on a substrate 304. The array 320 includes an aperture layer 322, disposed on the substrate 304, which includes a set of apertures 324 for respective pixels 301 in the array 320. The apertures 324 are aligned with the shutter assemblies 302 in each pixel. In some implementations, the substrate 304 is made of a transparent material, such as glass or plastic. In some other implementations, the substrate 304 is made of an opaque material, but in which holes are etched to form the apertures 324.

The shutter assembly 302 together with the actuator 303 can be made bi-stable. That is, the shutters can exist in at least two equilibrium positions (e.g., open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 also can be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as the spring 207 in the shutter-based light modulator 200 depicted in FIG. 2A, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on” or “off” optical states in each pixel. Certain forms of coded area division gray scale are possible where multiple MEMS light modulators in the pixel are provided, and where apertures 324, which are associated with each of the light modulators, have unequal areas.

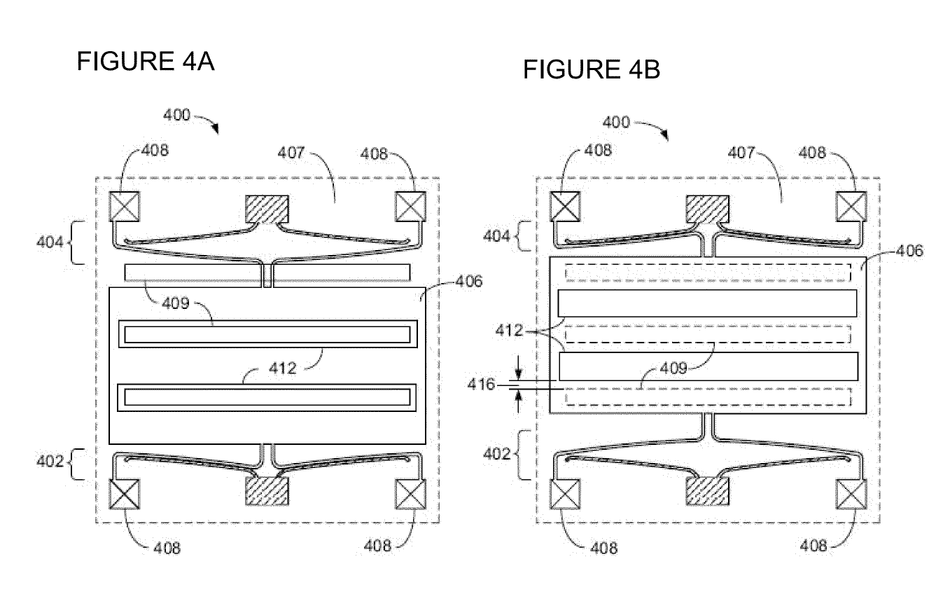

FIGS. 4A and 4B show example views of a dual actuator shutter assembly 400. The dual actuator shutter assembly 400, as depicted in FIG. 4A, is in an open state. FIG. 4B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. By analogy to the control matrix 300 of FIG. 3A, a control matrix suitable for use with the shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 4B, the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 4B shows a predefined overlap 416 between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

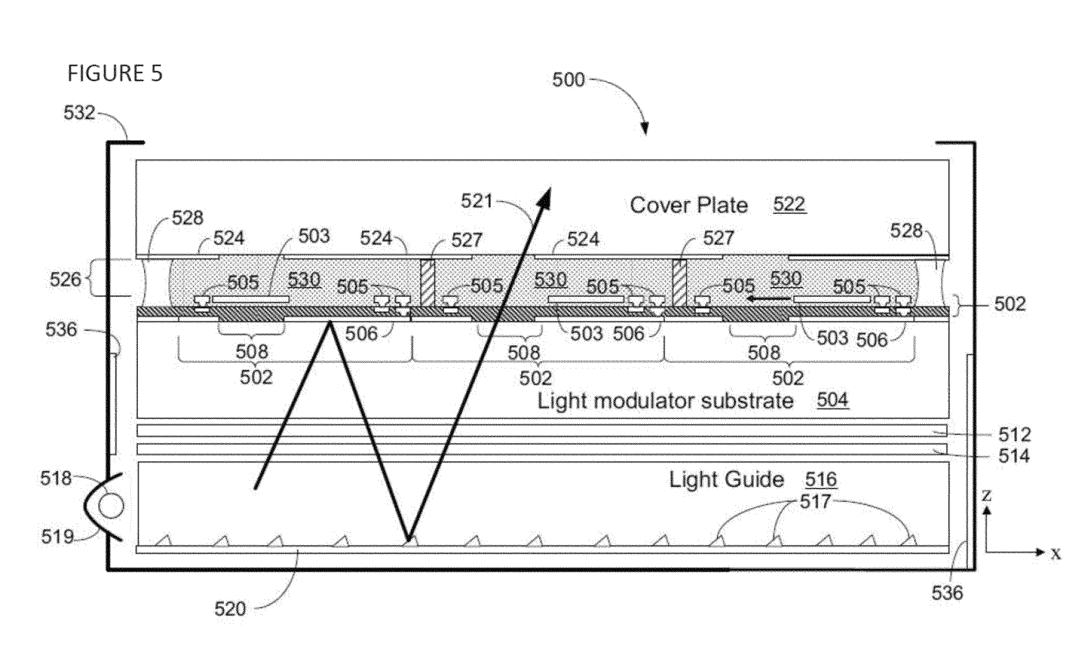

FIG. 5 shows an example cross sectional view of a display apparatus 500 incorporating shutter-based light modulators (shutter assemblies) 502. Each shutter assembly 502 incorporates a shutter 503 and an anchor 505. Not shown are the compliant beam actuators which, when connected between the anchors 505 and the shutters 503, help to suspend the shutters 503 a short distance above the surface. The shutter assemblies 502 are disposed on a transparent substrate 504, such as made of plastic or glass. A rear-facing reflective aperture layer 506, disposed on the substrate 504, defines a plurality of surface apertures 508 located beneath the closed positions of the shutters 503 of the shutter assemblies 502. The reflective aperture layer 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition (CVD). In some implementations, the reflective aperture layer 506 can be formed from a mirror, such as a dielectric mirror. A dielectric mirror can be fabricated as a stack of dielectric thin films which alternate between materials of high and low refractive index. The vertical gap which separates the shutters 503 from the reflective aperture layer 506, within which the shutter is free to move, is in the range of 0.5 to 10 microns. The magnitude of the vertical gap is preferably less than the lateral overlap between the edge of shutters 503 and the edge of apertures 508 in the closed state, such as the overlap 416 depicted in FIG. 4B.

The display apparatus 500 includes an optional diffuser 512 and/or an optional brightness enhancing film 514 which separate the substrate 504 from a planar light guide 516. The light guide 516 includes a transparent, i.e., glass or plastic material. The light guide 516 is illuminated by one or more light sources 518, forming a backlight 515. The light sources 518 can be, for example, and without limitation, incandescent lamps, fluorescent lamps, lasers or light emitting diodes (LEDs) (generically referred to as “lamps”). A reflector 519 helps direct light from light source 518 towards the light guide 516. A front-facing reflective film 520 is disposed behind the backlight 515, reflecting light towards the shutter assemblies 502. Light rays, such as ray 521 from the backlight 515 that do not pass through one of the shutter assemblies 502, will be returned to the backlight 515 and reflected again from the film 520. In this fashion light that fails to leave the display apparatus 500 to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the light source 518 towards the apertures 508 and hence toward the front of the display apparatus 500. The light redirectors 517 can be molded into the plastic body of the light guide 516 with shapes that can be alternately triangular, trapezoidal, or curved in cross section. The density of the prisms 517 generally increases with distance from the light source 518.

In some implementations, the aperture layer 506 can be made of a light absorbing material, and in alternate implementations the surfaces of shutter 503 can be coated with either a light absorbing or a light reflecting material. In some other implementations, the aperture layer 506 can be deposited directly on the surface of the light guide 516. In some implementations, the aperture layer 506 need not be disposed on the same substrate as the shutters 503 and anchors 505 (such as in the MEMS-down configuration described below).

In some implementations, the light source 518 can include lamps of different colors, for instance, the colors red, green and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps, or red, green, blue and yellow lamps. In some other implementations, the light source 518 may include cyan, magenta, yellow and white lamps, red, green, blue and white lamps. In some other implementations, additional lamps may be included in the light source 518. For example, if using five colors, the light source 518 may include red, green, blue, cyan and yellow lamps. In some other implementations, the light source 518 may include white, orange, blue, purple and green lamps or white, blue, yellow, red and cyan lamps. If using six colors, the light source 518 may include red, green, blue, cyan, magenta and yellow lamps or white, cyan, magenta, yellow, orange and green lamps.

A cover plate 522 forms the front of the display apparatus 500. The rear side of the cover plate 522 can be covered with a black matrix 524 to increase contrast. In alternate implementations the cover plate includes color filters, for instance distinct red, green, and blue filters corresponding to different ones of the shutter assemblies 502. The cover plate 522 is supported a predetermined distance away from the shutter assemblies 502 forming a gap 526. The gap 526 is maintained by mechanical supports or spacers 527 and/or by an adhesive seal 528 attaching the cover plate 522 to the substrate 504.

The adhesive seal 528 seals in a fluid 530. The fluid 530 is engineered with viscosities preferably below about 10 centipoise and with relative dielectric constant preferably above about 2.0, and dielectric breakdown strengths above about 10⁴ V/cm. The fluid 530 also can serve as a lubricant. In some implementations, the fluid 530 is a hydrophobic liquid with a high surface wetting capability. In alternate implementations, the fluid 530 has a refractive index that is either greater than or less than that of the substrate 504.

Displays that incorporate mechanical light modulators can include hundreds, thousands, or in some cases, millions of moving elements. In some devices, every movement of an element provides an opportunity for static friction to disable one or more of the elements. This movement is facilitated by immersing all the parts in a fluid (also referred to as fluid 530) and sealing the fluid (e.g., with an adhesive) within a fluid space or gap in a MEMS display cell. The fluid 530 is usually one with a low coefficient of friction, low viscosity, and minimal degradation effects over the long term. When the MEMS-based display assembly includes a liquid for the fluid 530, the liquid at least partially surrounds some of the moving parts of the MEMS-based light modulator. In some implementations, in order to reduce the actuation voltages, the liquid has a viscosity below 70 centipoise. In some other implementations, the liquid has a viscosity below 10 centipoise. Liquids with viscosities below 70 centipoise can include materials with low molecular weights: below 4000 grams/mole, or in some cases below 400 grams/mole. Fluids 530 that also may be suitable for such implementations include, without limitation, de-ionized water, methanol, ethanol and other alcohols, paraffins, olefins, ethers, silicone oils, fluorinated silicone oils, or other natural or synthetic solvents or lubricants. Useful fluids can be polydimethylsiloxanes (PDMS), such as hexamethyldisiloxane and octamethyltrisiloxane, or alkyl methyl siloxanes such as hexylpentamethyldisiloxane. Useful fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. Other fluids considered for these display assemblies include butyl acetate and dimethylformamide. Still other useful fluids for these displays include hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

A sheet metal or molded plastic assembly bracket 532 holds the cover plate 522, the substrate 504, the backlight 515 and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of the light guide 516 back into the light guide 516. Not depicted in FIG. 5 are electrical interconnects which provide control signals as well as power to the shutter assemblies 502 and the light source 518.

The display apparatus 500 is referred to as the MEMS-up configuration, wherein the MEMS-based light modulators are formed on a front surface of the substrate 504, i.e., the surface that faces toward the viewer. The shutter assemblies 502 are built directly on top of the reflective aperture layer 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in the display apparatus 500 and is oriented such that the MEMS-based light modulators are positioned on the rear surface of the top substrate, i.e., the surface that faces away from the viewer and toward the light guide 516. The MEMS-based light modulators are thereby positioned directly opposite to and across a gap from the reflective aperture layer 506. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures is preferably less than 10 microns, or a distance that is less than the overlap between shutters and apertures, such as overlap 416.

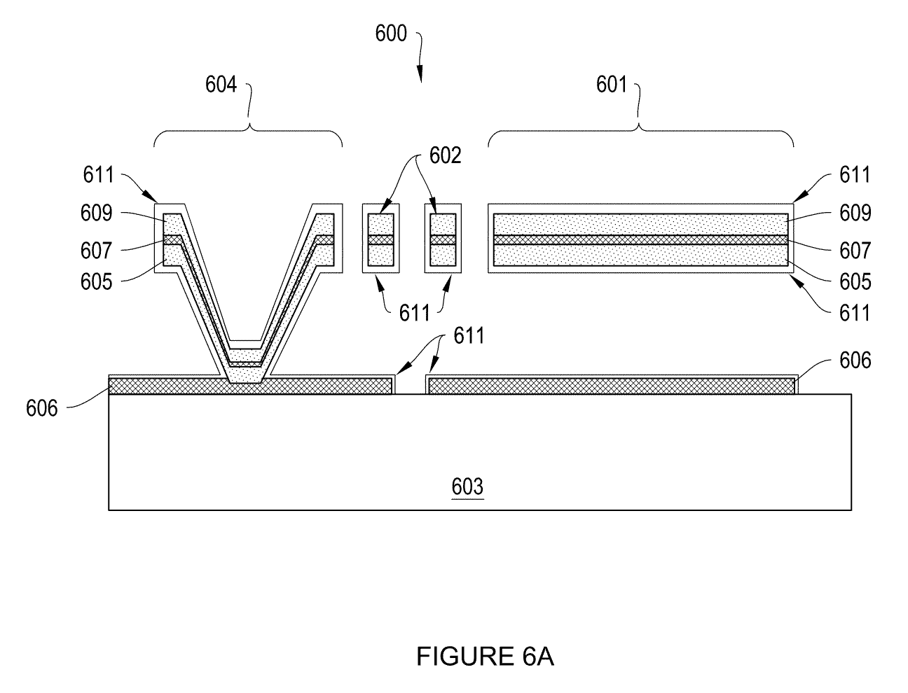

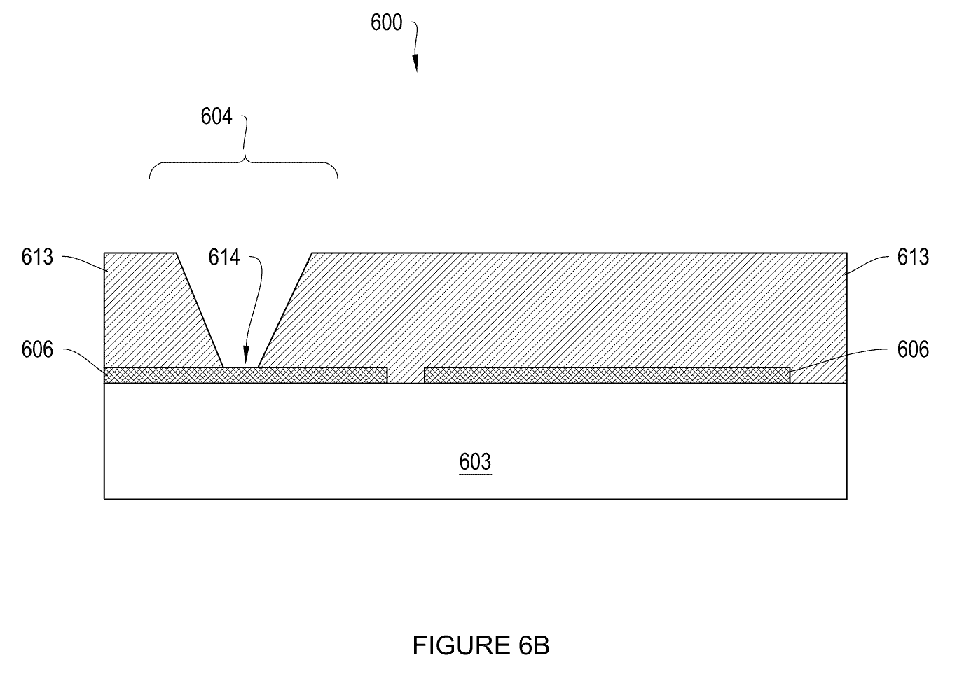

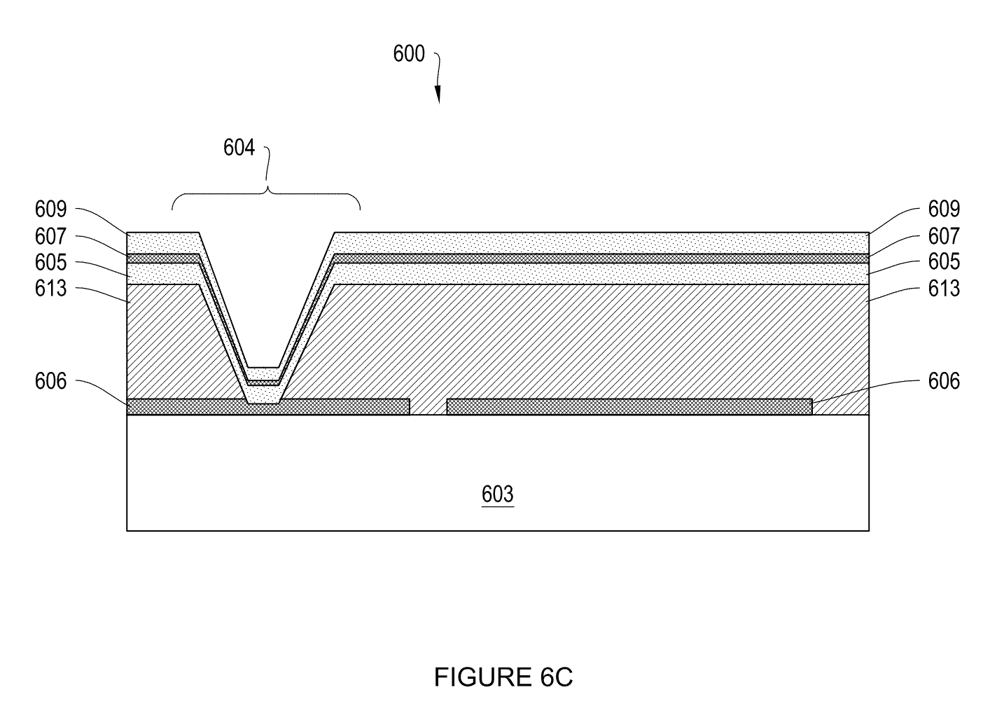

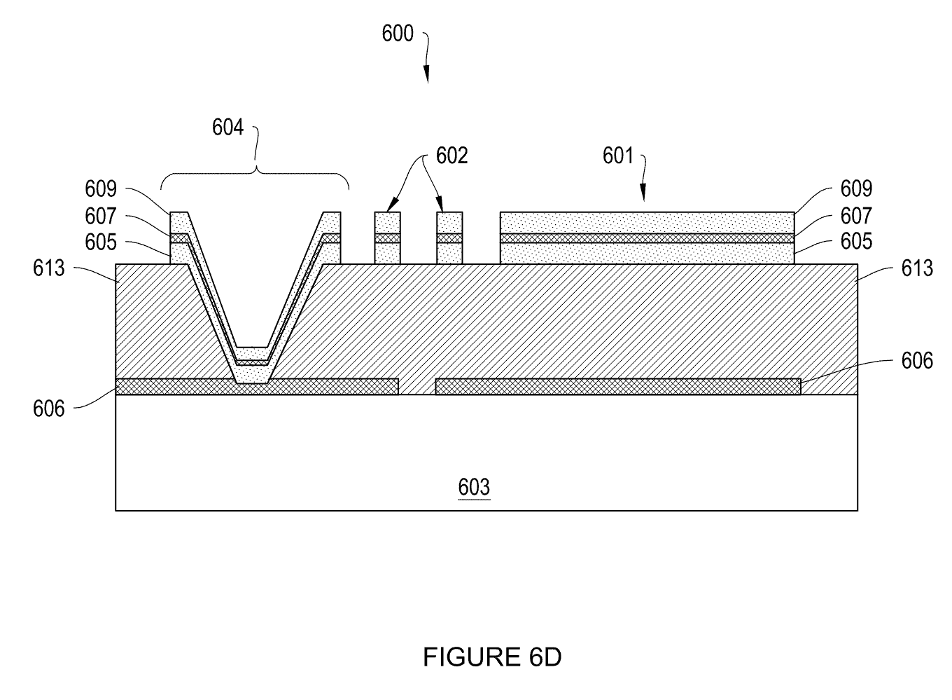

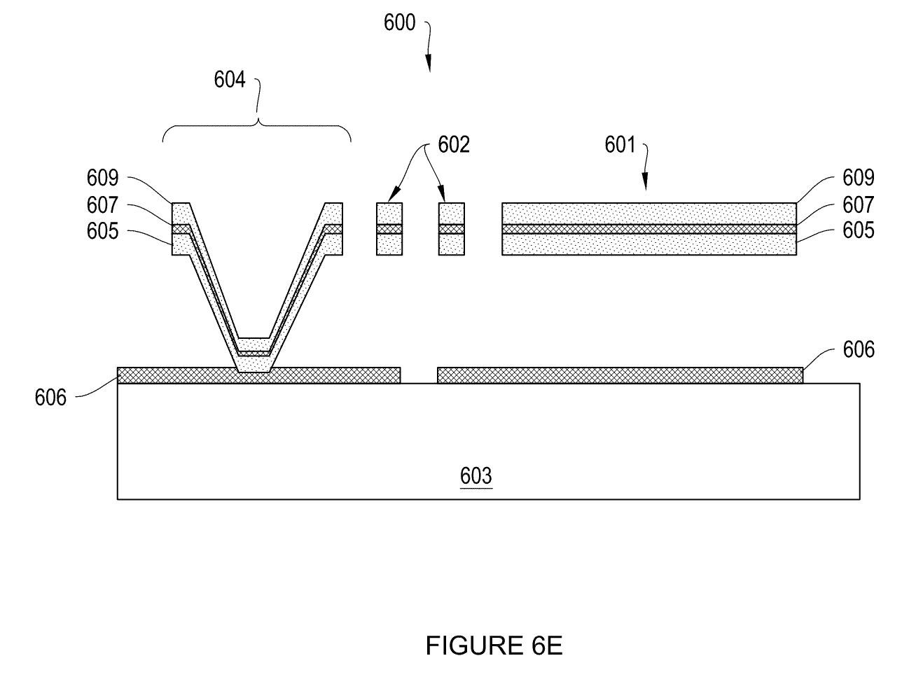

FIGS. 6A-6E show cross sectional views of stages of construction of an example composite shutter assembly. FIG. 6A shows an example cross sectional diagram of a completed composite shutter assembly 600. The shutter assembly 600 includes a shutter 601, two compliant beams 602, and an anchor structure 604 built-up on a substrate 603 and an aperture layer 606. The elements of the composite shutter assembly 600 include a first mechanical layer 605, a conductor layer 607, a second mechanical layer 609, and an encapsulating dielectric 611. At least one of the mechanical layers 605 or 609 can be deposited to thicknesses in excess of 0.15 microns, as one or both of the mechanical layers 605 or 609 serves as the principal load bearing and mechanical actuation member for the shutter assembly 600, though in some implementations, the mechanical layers 605 and 609 may be thinner. Candidate materials for the mechanical layers 605 and 609 include, without limitation, metals such as aluminum (Al), copper (Cu), nickel (Ni), chromium (Cr), molybdenum (Mo), titanium (Ti), tantalum (Ta), niobium (Nb), neodymium (Nd), or alloys thereof; dielectric materials such as aluminum oxide (Al₂O₃), silicon oxide (SiO₂), tantalum pentoxide (Ta₂O₅), or silicon nitride (Si₃N₄); or semiconducting materials such as diamond-like carbon, silicon (Si), germanium (Ge), gallium arsenide (GaAs), cadmium telluride (CdTe) or alloys thereof. At least one of the layers, such as the conductor layer 607, should be electrically conducting so as to carry charge on to and off of the actuation elements. Candidate materials include, without limitation, Al, Cu, Ni, Cr, Mo, Ti, Ta, Nb, Nd, or alloys thereof or semiconducting materials such as diamond-like carbon, Si, Ge, GaAs, CdTe or alloys thereof. In some implementations employing semiconductor layers, the semiconductors are doped with impurities such as phosphorus (P), arsenic (As), boron (B), or Al. FIG. 6A depicts a sandwich configuration for the composite in which the mechanical layers 605 and 609, having similar thicknesses and mechanical properties, are deposited on either side of the conductor layer 607. In some implementations, the sandwich structure helps to ensure that stresses remaining after deposition and/or stresses that are imposed by temperature variations will not act to cause bending, warping or other deformation of the shutter assembly 600.

In some implementations, the order of the layers in the composite shutter assembly 600 can be inverted, such that the outside of the shutter assembly 600 is formed from a conductor layer while the inside of the shutter assembly 600 is formed from a mechanical layer.

The shutter assembly 600 can include an encapsulating dielectric 611. In some implementations, dielectric coatings can be applied in conformal fashion, such that all exposed bottom, top, and side surfaces of the shutter 601, the anchor 604, and the beams 602 are uniformly coated. Such thin films can be grown by thermal oxidation and/or by conformal CVD of an insulator such as Al₂O₃, chromium (III) oxide (Cr₂O₃), titanium oxide (TiO₂), hafnium oxide (HfO₂), vanadium oxide (V₂O₅), niobium oxide (Nb₂O₅), Ta₂O₅, SiO₂, or Si₃N₄, or by depositing similar materials via atomic layer deposition. The dielectric coating layer can be applied with thicknesses in the range of 10 nm to 1 micron. In some implementations, sputtering and evaporation can be used to deposit the dielectric coating onto sidewalls.

FIGS. 6B-6E show example cross sectional views of the results of certain intermediate manufacturing stages of an example process used to form the shutter assembly 600 depicted in FIG. 6A. In some implementations, the shutter assembly 600 is built on top of a pre-existing control matrix, such as an active matrix array of thin film transistors, such as the control matrices depicted in FIGS. 3A and 3B.

FIG. 6B shows a cross sectional view of the results of a first stage in an example process of forming the shutter assembly 600. As depicted in FIG. 6B, a sacrificial layer 613 is deposited and patterned. In some implementations, polyimide is used as a sacrificial layer material. Other candidate sacrificial layer materials include, without limitation, polymer materials such as polyamide, fluoropolymer, benzocyclobutene, polyphenylquinoxylene, parylene, or polynorbornene. These materials are chosen for their ability to planarize rough surfaces, maintain mechanical integrity at processing temperatures in excess of 250° C., and their ease of etch and/or thermal decomposition during removal. In other implementations, the sacrificial layer 613 is formed from a photoresist, such as polyvinyl acetate, polyvinyl ethylene, and phenolic or novolac resins. An alternate sacrificial layer material used in some implementations is SiO₂, which can be removed preferentially as long as other electronic or structural layers are resistant to the hydrofluoric acid solutions used for its removal. One such suitable resistant material is Si₃N₄. Another alternate sacrificial layer material is Si, which can be removed preferentially as long as electronic or structural layers are resistant to the fluorine plasmas or xenon difluoride (XeF₂) used for its removal, such as most metals and Si₃N₄. Yet another alternate sacrificial layer material is Al, which can be removed preferentially as long as other electronic or structural layers are resistant to strong base solutions, such as concentrated sodium hydroxide (NaOH) solutions. Suitable materials include, for example, Cr, Ni, Mo, Ta and Si. Still another alternate sacrificial layer material is Cu, which can be removed preferentially as long as other electronic or structural layers are resistant to nitric or sulfuric acid solutions. Such materials include, for example, Cr, Ni, and Si.

Next the sacrificial layer 613 is patterned to expose holes or vias at the anchor regions 604. In implementations employing polyimide or other non-photoactive materials as the sacrificial layer material, the sacrificial layer material can be formulated to include photoactive agents, allowing regions exposed through a UV photomask to be preferentially removed in a developer solution. Sacrificial layers formed from other materials can be patterned by coating the sacrificial layer 613 in an additional layer of photoresist, photopatterning the photoresist, and finally using the photoresist as an etching mask. The sacrificial layer 613 alternatively can be patterned by coating the sacrificial layer 613 with a hard mask, which can be a thin layer of SiO₂ or a metal such as Cr. A photopattern is then transferred to the hard mask by way of photoresist and wet chemical etching. The pattern developed in the hard mask can be resistant to dry chemical, anisotropic, or plasma etching—techniques which can be used to impart deep and narrow anchor holes into the sacrificial layer 613.

After the anchor regions 604 have been opened in the sacrificial layer 613, the exposed and underlying conducting surface 614 can be etched, either chemically or via the sputtering effects of a plasma, to remove any surface oxide layers. Such a contact etching stage can improve the ohmic contact between the underlying conducting surface 614 and the shutter material. After patterning of the sacrificial layer 613, any photoresist layers or hard masks can be removed through use of either solvent cleaning or acid etching.

Next, in the process for building the shutter assembly 600, as depicted in FIG. 6C, the shutter materials are deposited. The shutter assembly 600 is composed of multiple thin films: the first mechanical layer 605, the conductor layer 607 and the second mechanical layer 609. In some implementations, the first mechanical layer 605 is an amorphous silicon (a-Si) layer, the conductor layer 607 is Al and the second mechanical layer 609 is a-Si. The first mechanical layer 605, the conductor layer 607, and the second mechanical layer 609 are deposited at a temperature which is below that at which physical degradation occurs for the sacrificial layer 613. For instance, polyimide decomposes at temperatures above about 400° C. Therefore, in some implementations, the first mechanical layer 605, the conductor layer 607 and the second mechanical layer 609 are deposited at temperatures below about 400° C., allowing usage of polyimide as a sacrificial layer material. In some implementations, hydrogenated amorphous silicon (a-Si:H) is a useful mechanical material for the first and second mechanical layers 605 and 609 since it can be grown to thicknesses in the range of about 0.15 to about 3 microns, in a relatively stress-free state, by way of plasma-enhanced chemical vapor deposition (PECVD) from silane gas at temperatures in the range of about 250 to about 350° C. In some of such implementations, phosphine gas (PH₃) is used as a dopant so that the a-Si can be grown with resistivities below about 1 ohm-cm. In alternate implementations, a similar PECVD technique can be used for the deposition of Si₃N₄, silicon-rich Si₃N₄, or SiO₂ materials as the first mechanical layer 605 or for the deposition of diamond-like carbon, Ge, SiGe, CdTe, or other semiconducting materials for the first mechanical layer 605. An advantage of the PECVD deposition technique is that the deposition can be quite conformal, that is, it can coat a variety of inclined surfaces or the inside surfaces of narrow via holes. Even if the anchor or via holes which are cut into the sacrificial layer material present nearly vertical sidewalls, the PECVD technique can provide a substantially continuous coating between the bottom and top horizontal surfaces of the anchor.

In addition to the PECVD technique, alternate suitable techniques available for the growth of the first and second mechanical layers 605 and 609 include RF or DC sputtering, metal-organic CVD, evaporation, electroplating or electroless plating.

For the conductor layer 607, in some implementations, a metal thin film, such as Al, is utilized. In some other implementations, alternative metals, such as Cu, Ni, Mo, or Ta can be chosen. The inclusion of such a conducting material serves two purposes. It reduces the overall sheet resistance of the shutter 601, and it helps to block the passage of visible light through the shutter 601, since a-Si, if less than about 2 microns thick, as may be used in some implementations of the shutter 601, can transmit visible light to some degree. The conducting material can be deposited either by sputtering or, in a more conformal fashion, by CVD techniques, electroplating, or electroless plating.

FIG. 6D shows the results of the next set of processing stages used in the formation of the shutter assembly 600. The first mechanical layer 605, the conductor layer 607, and the second mechanical layer 609 are photomasked and etched while the sacrificial layer 613 is still on the substrate 603. First, a photoresist material is applied, then exposed through a photomask, and then developed to form an etch mask. Amorphous silicon, Si₃N₄, and SiO₂ can then be etched in fluorine-based plasma chemistries. SiO₂ mechanical layers also can be etched using HF wet chemicals; and any metals in the conductor layer 607 can be etched with either wet chemicals or chlorine-based plasma chemistries.

The pattern shapes applied through the photomask can influence the mechanical properties, such as stiffness, compliance, and the voltage response in the actuator and shutter 601 of the shutter assembly 600. The shutter assembly 600 includes the compliant beams 602, shown in cross section. Each compliant beam 602 is shaped such that the width is less than the total height or thickness of the shutter material. In some implementations, the beam dimensional ratio is maintained at about 1.4:1 or greater, with the compliant beams 602 being taller or thicker than they are wide.

The results of subsequent stages of the example manufacturing process for building the shutter assembly 600 are depicted in FIG. 6E. The sacrificial layer 613 is removed, which frees-up all moving parts from the substrate 603, except at the anchor points. In some implementations, polyimide sacrificial materials are removed in an oxygen plasma. Other polymer materials used for the sacrificial layer 613 also can be removed in an oxygen plasma, or in some cases by thermal pyrolysis. Some sacrificial layer materials (such as SiO₂) can be removed by wet chemical etching or by vapor phase etching.

In a final process, the results of which are depicted in FIG. 6A, the encapsulating dielectric 611 is deposited on all exposed surfaces of the shutter assembly 600. In some implementations, the encapsulating dielectric 611 can be applied in a conformal fashion, such that all bottom, top, and side surfaces of the shutter 601 and the beams 602 are uniformly coated using CVD. In some other implementations, only the top and side surfaces of the shutter 601 are coated. In some implementations, Al₂O₃ is used for the encapsulating dielectric 611 and is deposited by atomic layer deposition to thicknesses in the range of about 10 to about 100 nanometers.

Finally, anti-stiction coatings can be applied to the surfaces of the shutter 601 and the beams 602. These coatings prevent the unwanted stickiness or adhesion between two independent beams of an actuator. Suitable coatings include carbon films (both graphite and diamond-like) as well as fluoropolymers, and/or low vapor pressure lubricants, as well as chlorosilanes, hydrocarbon chlorosilanes, fluorocarbon chlorosilanes, such as methoxy-terminated silanes, perfluoronated, amino-silanes, siloxanes and carboxylic acid based monomers and species. These coatings can be applied by either exposure to a molecular vapor or by decomposition of precursor compounds by way of CVD. Anti-stiction coatings also can be created by the chemical alteration of shutter surfaces, such as by fluoridation, silanization, siloxidation, or hydrogenation of insulating surfaces.

One class of suitable actuators for use in EMS-based shutter displays include compliant actuator beams for controlling shutter motion that is transverse to or in-the-plane of the display substrate. The voltage employed for the actuation of such shutter assemblies decreases as the actuator beams become more compliant. The control of actuated motion also improves if the beams are shaped such that in-plane motion is preferred or promoted with respect to out-of-plane motion. Thus, in some implementations, the compliant actuator beams have a rectangular cross section, such that the beams are taller or thicker than they are wide.

The stiffness of a long rectangular beam with respect to bending within a particular plane scales with the thinnest dimension of that beam in that plane to the third power. It is therefore advantageous to reduce the width of the compliant beams to reduce the actuation voltages for in-plane motion. When using conventional photolithography equipment to define and fabricate the shutter and actuator structures, however, the minimum width of the beams can be limited to the resolution of the optics. And although photolithography equipment has been developed for defining patterns in photoresist with narrow features, such equipment is expensive, and the areas over which patterning can be accomplished in a single exposure are limited. For economical photolithography over large panels of glass or other transparent substrates, the patterning resolution or minimum feature size is typically limited to several microns.

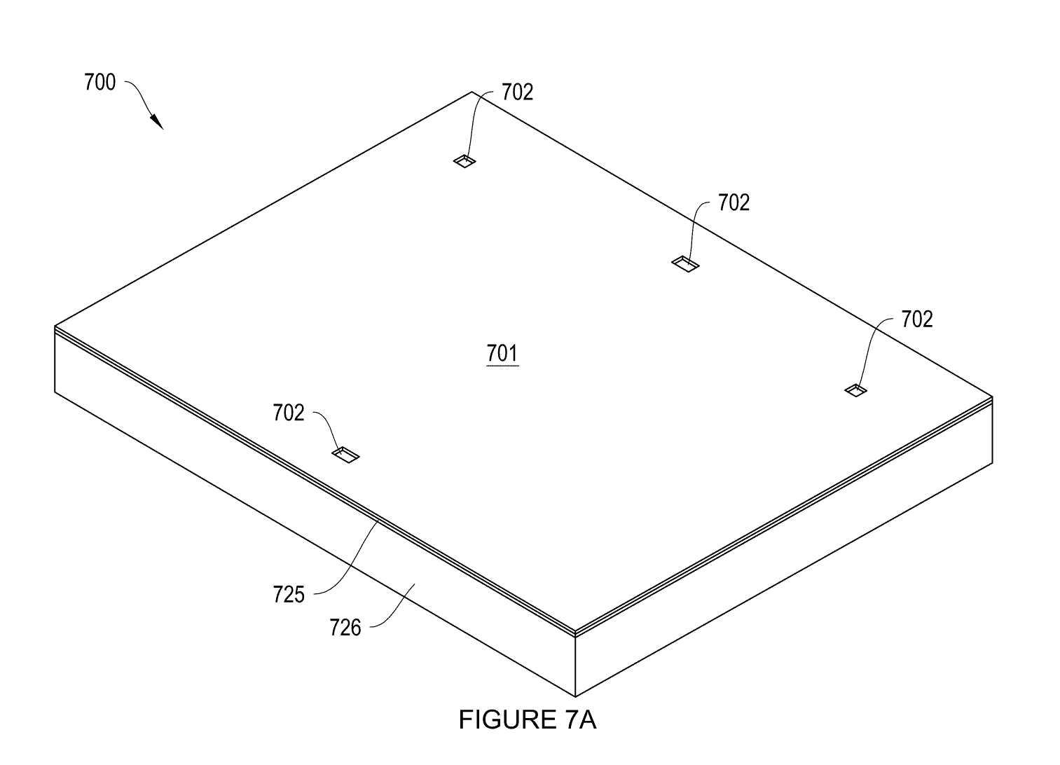

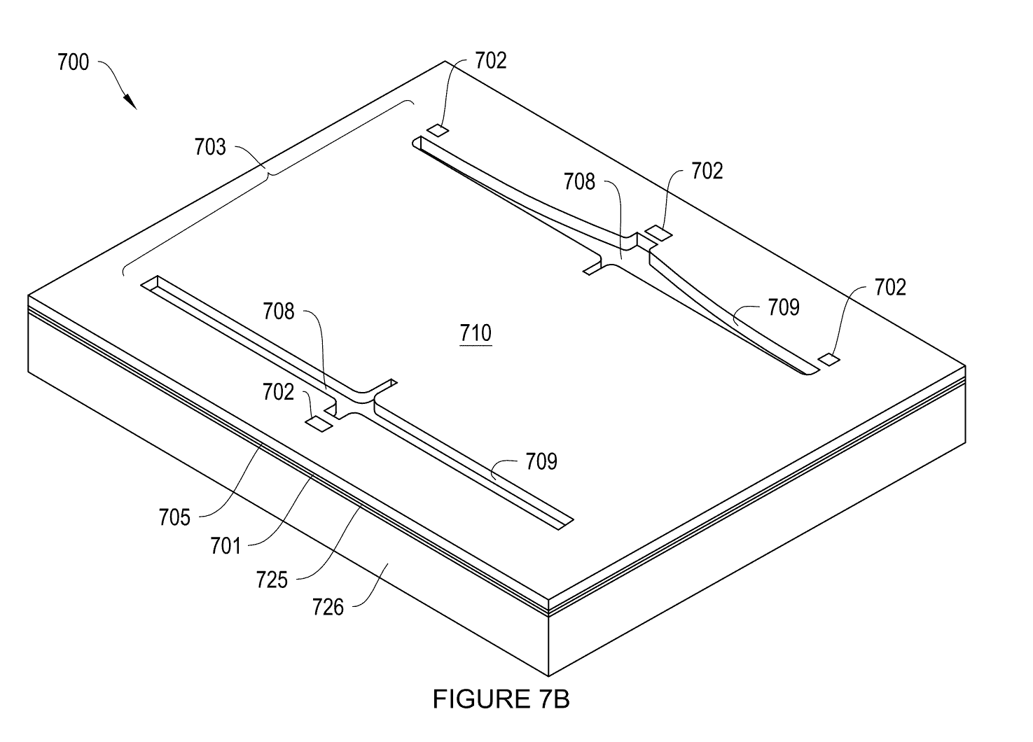

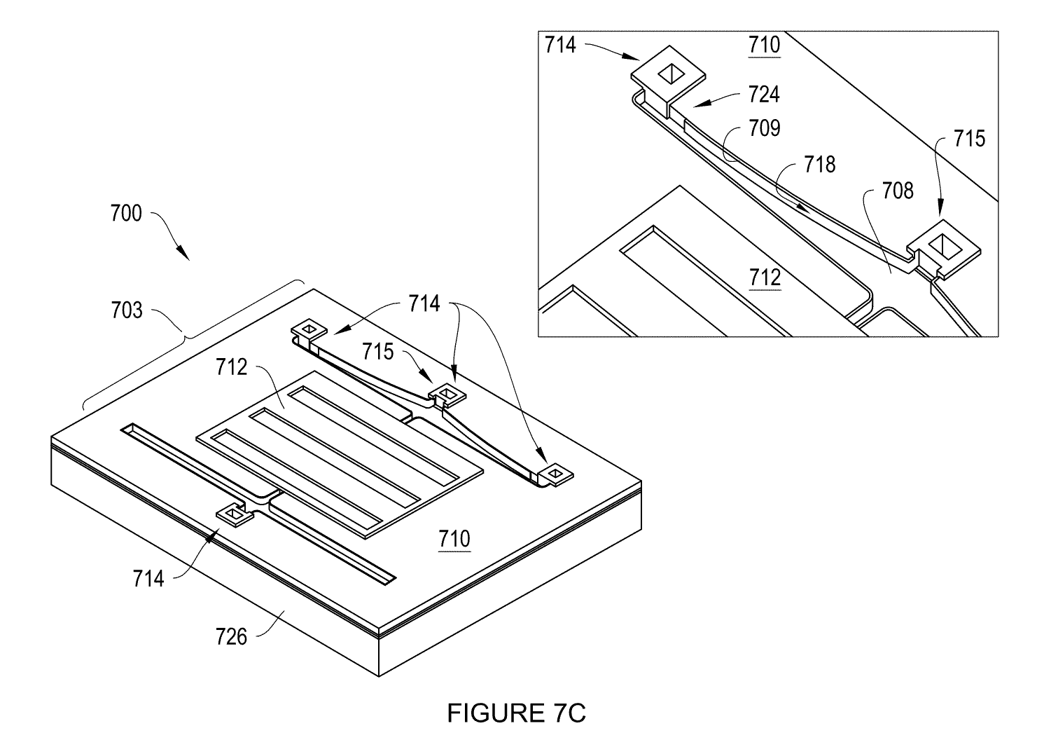

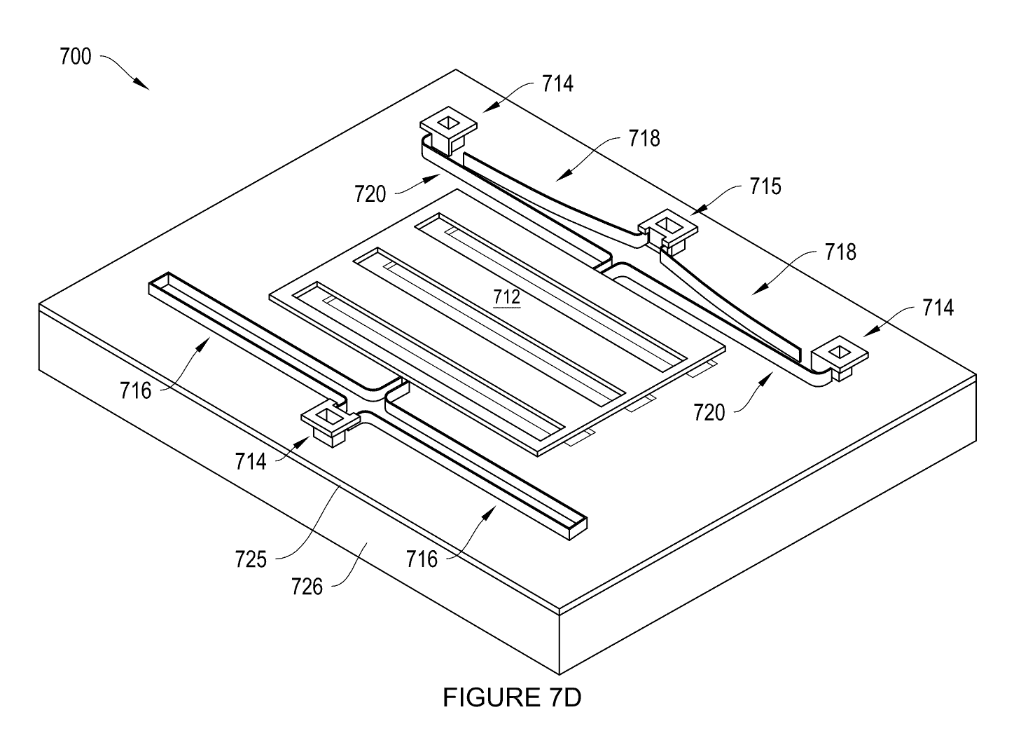

FIGS. 7A-7D show isometric views of stages of construction of an example shutter assembly 700 with narrow sidewall beams. This alternate process yields compliant actuator beams 718 and 720 and a compliant spring beam 716 (collectively referred to as “sidewall beams 716, 718 and 720”), which have a width well below the conventional lithography limits on large glass panels. In the process depicted in FIGS. 7A-7D, the compliant beams of shutter assembly 700 are formed as sidewall features on a mold made from a sacrificial material. The process is referred to as a sidewall beams process.

The process of forming the shutter assembly 700 with the sidewall beams 716, 718 and 720 begins, as depicted in FIG. 7A, with the deposition and patterning of a first sacrificial material 701. The pattern defined in the first sacrificial material 701 creates openings or vias 702 within which anchors for the shutter assembly 700 eventually will be formed. The deposition and patterning of the first sacrificial material 701 is similar in concept, and uses similar materials and techniques, as those described for the deposition and patterning described in relation to FIGS. 6A-6E.

The process of forming the sidewall beams 716, 718 and 720 continues with the deposition and patterning of a second sacrificial material 705. FIG. 7B shows the shape of a mold 703 that is created after patterning of the second sacrificial material 705. The mold 703 also includes the first sacrificial material 701 with its previously defined vias 702. The mold 703 in FIG. 7B includes two distinct horizontal levels. The bottom horizontal level 708 of the mold 703 is established by the top surface of the first sacrificial layer 701 and is accessible in those areas where the second sacrificial material 705 has been etched away. The top horizontal level 710 of the mold 703 is established by the top surface of the second sacrificial material 705. The mold 703 depicted in FIG. 7B also includes substantially vertical sidewalls 709. Materials for use as the first and second sacrificial materials 701 and 705 are described above with respect to the sacrificial layer 613 of FIGS. 6A-6E.

The process of forming the sidewall beams 716, 718 and 720 continues with the deposition and patterning of shutter material onto all of the exposed surfaces of the sacrificial mold 703, as depicted in FIG. 7C. Suitable materials for use in forming the shutter 712 are described above with respect to the first mechanical layer 605, the conductor layer 607, and the second mechanical layer 609 of FIGS. 6A-6E. The shutter material is deposited to a thickness of less than about 2 microns. In some implementations, the shutter material is deposited to have a thickness of less than about 1.5 microns. In some other implementations, the shutter material is deposited to have a thickness of less than about 1.0 microns, and as thin as about 0.10 microns. After deposition, the shutter material (which may be a composite of several materials as described above) is patterned, as depicted in FIG. 7C. First, a photoresist is deposited on the shutter material. The photoresist is then patterned. The pattern developed into the photoresist is designed such that the shutter material, after a subsequent etch stage, remains in the region of the shutter 712 as well as at the anchors 714.

The manufacturing process continues with applying an anisotropic etch, resulting in the structure depicted in FIG. 7C. The anisotropic etch of the shutter material is carried out in a plasma atmosphere with a voltage bias applied to the substrate 726 or to an electrode in proximity to the substrate 726. The biased substrate 726 (with electric field perpendicular to the surface of the substrate 726) leads to acceleration of ions toward the substrate 726 at an angle nearly perpendicular to the substrate 726. Such accelerated ions, coupled with the etching chemicals, lead to etch rates that are much faster in a direction that is normal to the plane of the substrate 726 as compared to directions parallel to the substrate 726. Undercut-etching of shutter material in the regions protected by a photoresist is thereby substantially eliminated. Along the sidewall surfaces 709 of the mold 703, which are substantially parallel to the track of the accelerated ions, the shutter material also is substantially protected from the anisotropic etch. Such protected sidewall shutter material form the sidewall beams 716, 718, and 720 for supporting the shutter 712. Along other (non-photoresist-protected) horizontal surfaces of the mold 703, such as the top horizontal surface 710 or the bottom horizontal surface 708, the shutter material has been substantially completely removed by the etch.

The anisotropic etch used to form the sidewall beams 716, 718 and 720 can be achieved in either an RF or DC plasma etching device as long as provision for electrical bias of the substrate 726 or of an electrode in close proximity of the substrate 726 is supplied. For the case of RF plasma etching, an equivalent self-bias can be obtained by disconnecting the substrate holder from the grounding plates of the excitation circuit, thereby allowing the substrate potential to float in the plasma. In some implementations, it is possible to provide an etching gas such as trifluoromethane (CHF₃), perfluorobutene (C₄F₈), or chloroform (CHCl₃) in which both carbon and hydrogen and/or carbon and fluorine are constituents in the etch gas. When coupled with a directional plasma, achieved again through voltage biasing of the substrate 726, the liberated carbon (C), hydrogen (H), and/or fluorine (F) atoms can migrate to the sidewalls 709 where they build up a passive or protective quasi-polymer coating. This quasi-polymer coating further protects the sidewall beams 716, 718 and 720 from etching or chemical attack.

The process of forming the sidewall beams 716, 718 and 720 is completed with the removal of the remainder of the second sacrificial material 705 and the first sacrificial material 701. The result is shown in FIG. 7D. The process of removing sacrificial material is similar to that described with respect to FIG. 6E. The material deposited on the sidewalls 709 of the mold 703 remain as the sidewall beams 716, 718 and 720. The sidewall beam 716 serves as a spring mechanically connecting the anchors 714 to the shutter 712, and also provides a passive restoring force and to counter the forces applied by the actuator formed from the compliant beams 718 and 720. The anchors 714 connect to an aperture layer 725. The sidewall beams 716, 718 and 720 are tall and narrow. The width of the sidewall beams 716, 718 and 720, as formed from the surface of the mold 703, is similar to the thickness of the shutter material as deposited. In some implementations, the width of sidewall beam 716 will be the same as the thickness of shutter 712. In some other implementations, the beam width will be about ½ the thickness of the shutter 712. The height of the sidewall beams 716, 718 and 720 is determined by the thickness of the second sacrificial material 705, or in other words, by the depth of the mold 703, as created during the patterning operation described in relation to FIG. 7B. As long as the thickness of the deposited shutter material is chosen to be less than about 2 microns, the process depicted in FIGS. 7A-7D is well suited for the production of narrow beams. In fact, for many applications the thickness range of 0.1 to 2.0 micron is quite suitable. Conventional photolithography would limit the patterned features shown in FIGS. 7A, 7B and 7C to much larger dimensions, for instance allowing minimum resolved features no smaller than 2 microns or 5 microns.

FIG. 7D depicts an isomeric view of the shutter assembly 700, formed after the release operation in the above-described process, yielding compliant beams with cross sections of high aspect ratios. As long as the thickness of the second sacrificial material 705 is, for example, greater than about 4 times larger than the thickness of the shutter material, the resulting ratio of beam height to beam width will be produced to a similar ratio, i.e., greater than about 4:1.

An optional stage, not illustrated above but included as part of the process leading to FIG. 7C, involves isotropic etching of the sidewall beam material to separate or decouple the compliant load beams 720 from the compliant drive beams 718. For instance, the shutter material at point 724 has been removed from the sidewall through use of an isotropic etch. An isotropic etch is one whose etch rate is substantially the same in all directions, so that sidewall material in regions such as point 724 is no longer protected. The isotropic etch can be accomplished in the typical plasma etch equipment as long as a bias voltage is not applied to the substrate 726. An isotropic etch also can be achieved using wet chemical or vapor phase etching techniques. Prior to this optional fourth masking and etch stage, the sidewall beam material exists essentially continuously around the perimeter of the recessed features in the mold 703. The fourth mask and etch stage is used to separate and divide the sidewall material, forming the distinct beams 718 and 720. The separation of the beams 718 and 720 at point 724 is achieved through a fourth process of photoresist dispense, and exposure through a mask. The photoresist pattern in this case is designed to protect the sidewall beam material against isotropic etching at all points except at the separation point 724.

As a final stage in the sidewall process, an encapsulating dielectric is deposited around the outside surfaces of the sidewall beams 716, 718 and 720.

In order to protect the shutter material deposited on the sidewalls 709 of the mold 703 and to produce the sidewall beams 716, 718 and 720 of substantially uniform cross section, some particular process guidelines can be followed. For instance, in FIG. 7B, the sidewalls 709 can be made as vertical as possible. Slopes at the sidewalls 709 and/or exposed surfaces become susceptible to the anisotropic etch. In some implementations, vertical sidewalls 709 can be produced by the patterning operation at FIG. 7B, such as the patterning of the second sacrificial material 705 in an anisotropic fashion. The use of an additional photoresist coating or a hard mask in conjunction with patterning of the second sacrificial layer 705 allows the use of aggressive plasmas and/or high substrate bias in the anisotropic etch of the second sacrificial material 705 while mitigating against excessive wear of the photoresist. Vertical sidewalls 709 also can be produced in photoimageable sacrificial materials as long as care is taken to control the depth of focus during the UV exposure and excessive shrinkage is avoided during final cure of the resist.

Another process guideline that helps during sidewall beam processing relates to the conformality of the shutter material deposition. The surfaces of the mold 703 can be covered with similar thicknesses of the shutter material, regardless of the orientation of those surfaces, either vertical or horizontal. Such conformality can be achieved when depositing with CVD. In particular, the following conformal techniques can be employed: PECVD, low pressure chemical vapor deposition (LPCVD), and atomic or self-limited layer deposition (ALD). In the above CVD techniques the growth rate of the thin film can be limited by reaction rates on a surface as opposed to exposing the surface to a directional flux of source atoms. In some implementations, the thickness of material grown on vertical surfaces is at least 50% of the thickness of material grown on horizontal surfaces. Alternatively, shutter materials can be conformally deposited from solution by electroless plating or electroplating, after a metal seed layer is provided that coats the surfaces before plating.

As described above, methods of creating shutters and electrostatic actuators for use in displays have involved the use of two sacrificial mold layers. A first layer was patterned to serve as a mold for the base of an anchor that supported the shutter over a substrate. The second mold layer was patterned to serve as a mold for the remainder of the anchors, the actuators and the shutter. By only using two mold layers, resulting structures included shutters and actuators that were invariably of the same height since the thickness of the first mold layer defined the distance of the shutters and actuators from the substrate, while the thickness of the second mold layer defined the height of both the shutters and the actuators. As a result, the true design potential of each of the shutter and the actuator were limited.

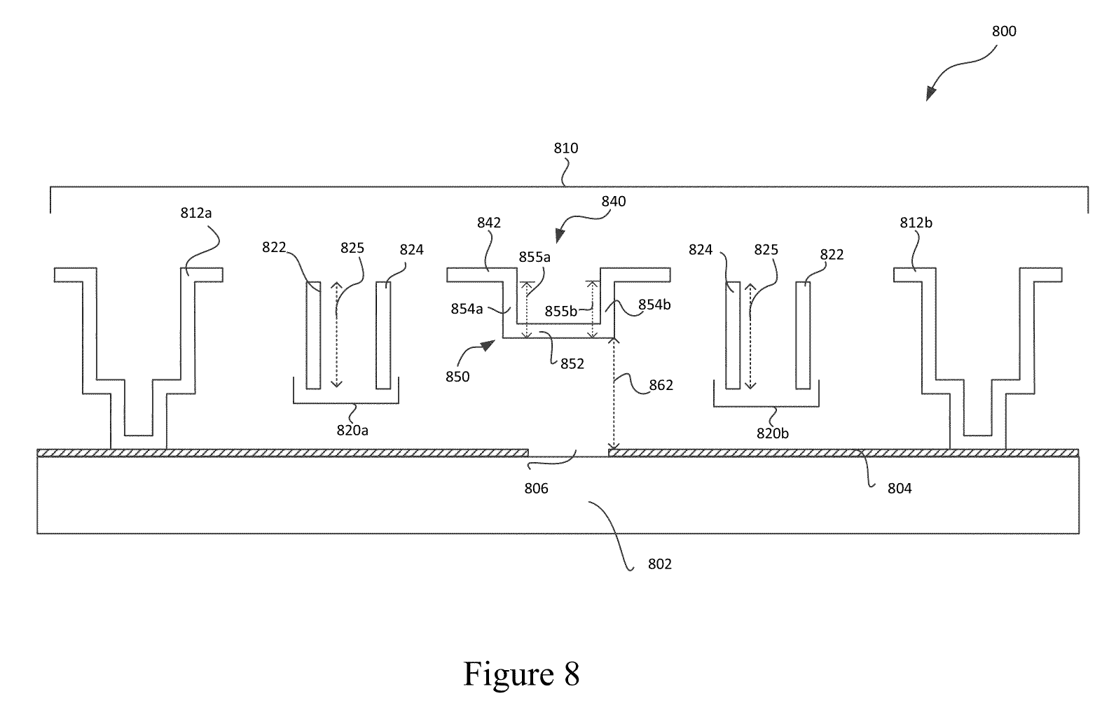

Greater flexibility to design alternative shutter assembly architectures can be provided by allowing the use of a third mold layer in the manufacture of a shutter assembly. In particular, the addition of the third mold layer provides an opportunity to form shutters and actuators that have separate heights corresponding to the thickness of the second mold layer, the third mold layer or both the second and third mold layers. In this way, a shutter assembly can be manufactured that includes an actuator and a shutter that has at least one protrusion. The protrusion can have a sidewall that has a height that corresponds to the thickness of the third mold layer, while the corresponding actuators can have heights that correspond to the thicknesses of both the second and third mold layers. An example of such a shutter assembly is described below with respect to FIG. 8.

FIG. 8 shows a cross-sectional view of a portion of an example EMS shutter-based display apparatus 800. The display apparatus 800 includes a substrate 802 having a light blocking layer 804, through which an aperture 806 is formed, and a shutter assembly 810.

The shutter assembly 810 is formed on the substrate 802 and includes anchors 812a and 812b that are configured to support a pair of electrostatic actuators 820a and 820b (generally referred to as actuators 820) and a shutter 840 over the substrate 802. The actuators 820 are responsible for moving the shutter 840 between states. The electrostatic actuator 820a is configured to drive the shutter 840 in a first direction, while the electrostatic actuator 820b is configured to drive the shutter 840 in a second direction, opposite the first direction. Each of the actuators 820 includes a drive beam electrode 822 and a load beam electrode 824 positioned opposite the drive beam electrode 822. The load beam electrodes 824 of the first and second actuators 820 are connected to the shutter 840 and are responsive to a drive voltage applied to a corresponding drive electrode 822. Each of the drive beam electrodes 822 and the load beam electrodes 824 has a primary face normal to the substrate 802. The electrostatic actuators 820 have a height 825 that corresponds to the heights of the drive electrodes 822 and the load electrodes 824. In particular, the height 825 of the drive beam and load beam electrodes 822 and 824 correspond to the height of the primary faces of the drive beam and load beam electrodes 822 and 824.

The shutter 840 includes a primary planar portion 842 that extends substantially parallel to the substrate 802. The shutter 840 also includes at least one protrusion 850. The protrusion 850 is defined by two sidewalls 854a and 854b (generally referred to as sidewalls 854), a pair of end walls that connect to the sidewalls 854a and 854b at both ends and a distal portion 852 that is parallel to the primary planar portion 842. The heights 855a and 855b of the sidewalls 854a and 854b (each generally referred to as a sidewall height 855) correspond to the depth of the protrusion 850. Each of the sidewalls 854a and 854b include a proximal end that is relatively closer to the substrate 802 on which the shutter 840 is formed than a distal end of the sidewalls 854a and 854b.

The sidewall heights 855a and 855b of the sidewalls 854a and 854b are substantially shorter than the height 825 of the actuators 820a and 820b. In particular, the top surfaces of the actuators 820 are substantially aligned with the top surface of the primary planar portion 842, while the bottom surfaces of the actuators 820, i.e., the surfaces facing the substrate 802, are closer to the substrate 802 than the bottom surface of the distal portion 852 of the shutter 840. The bottom surfaces of the actuators 820 correspond to a proximal end of the actuators, while the top surfaces of the actuators 820 correspond to a distal end of the actuators. The proximal ends of the actuators are relatively closer to the substrate 802 on which the actuators are formed than the distal ends. Stated in another way, the configuration of the shutter assembly 810 depicted in FIG. 8 illustrates a shutter 840 having a protrusion 850 which is shallower than the actuators 820a and 820b. A shallower-protrusion shutter, such as the shutter 840, allows for an increased distance 862 between the underlying substrate 802 and the shutter 840. This reduces the possibility of the shutter 840 touching down on the substrate 802 were the shutter 840 to experience out-of-plane motion towards the substrate 802. Furthermore, a shallower-protrusion shutter may have a faster speed through a fluid in which the shutter 840 is immersed within the display.

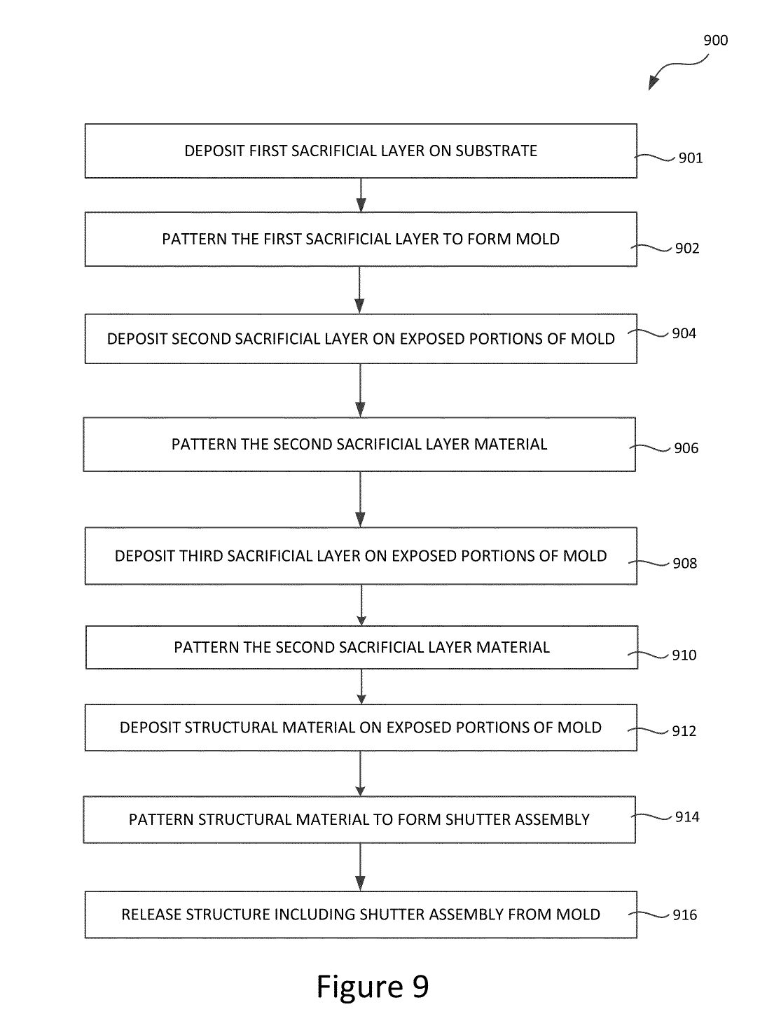

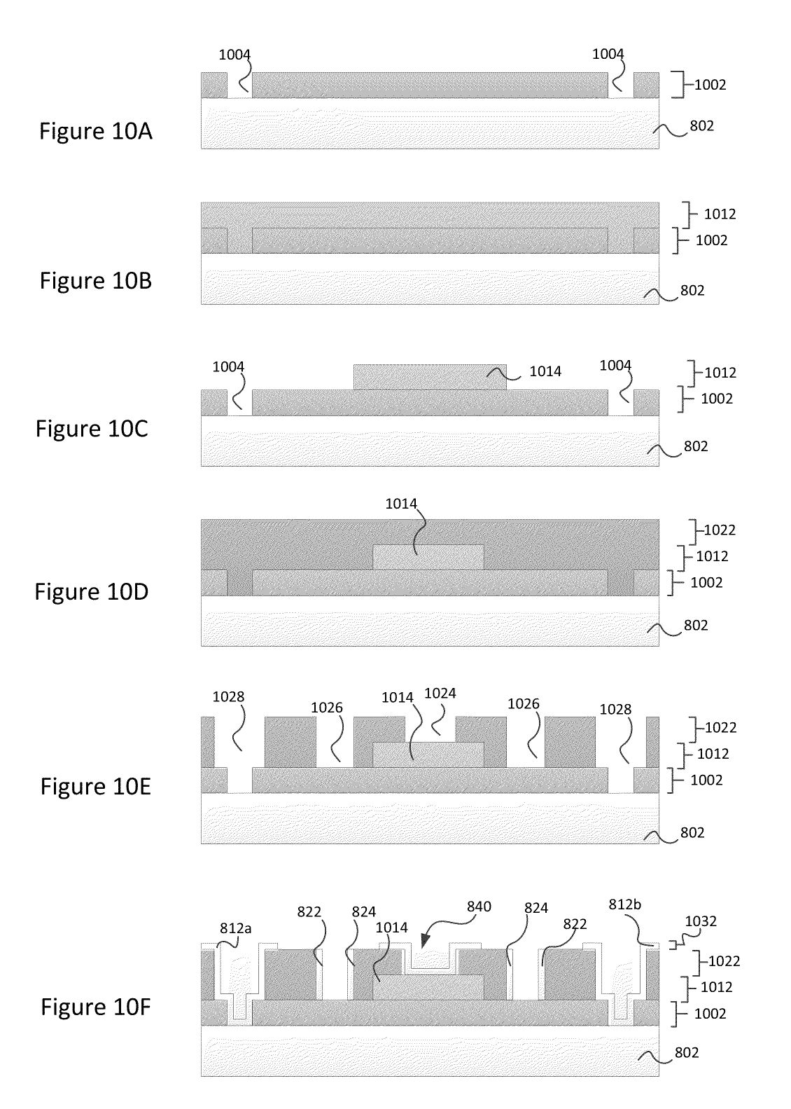

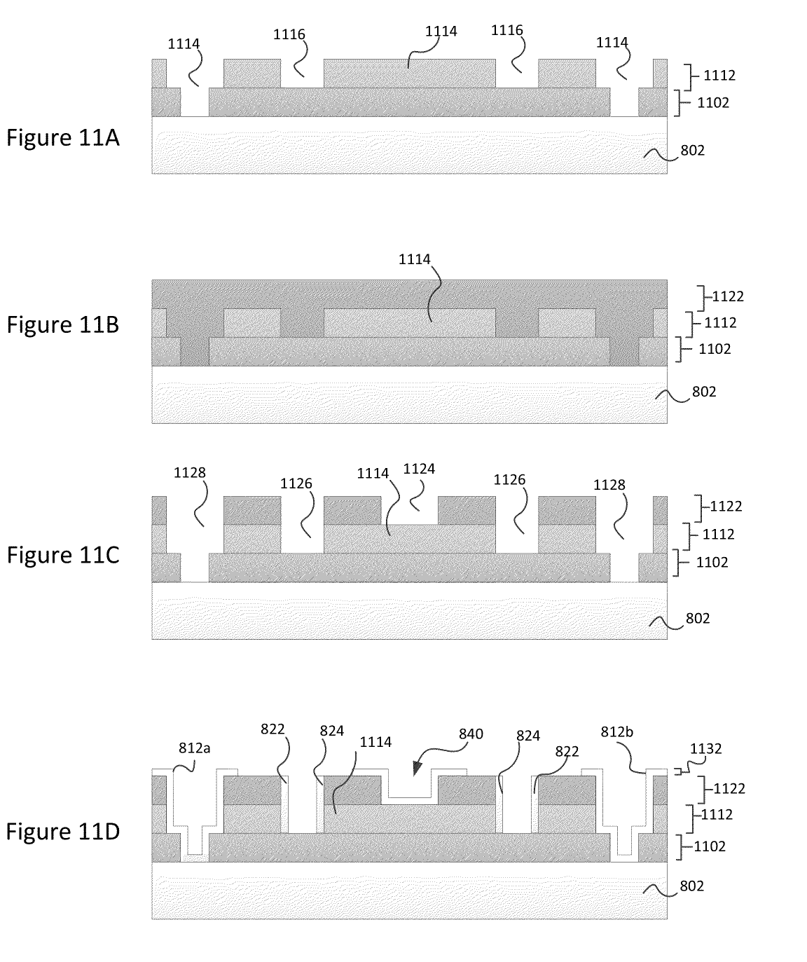

FIG. 9 shows a flow diagram of an example manufacturing process 900 of a display apparatus incorporating shutter assemblies including shutters having protrusions that have a depth substantially different from the height of corresponding electrostatic actuators. First, a mold is formed by depositing a first mold layer over a substrate (stage 901). The first mold layer is then patterned (stage 902). A second mold layer is then deposited over the exposed surfaces of the mold (stage 904). The second mold layer is then patterned (stage 906). Next, a third mold layer is deposited over exposed surfaces of the mold (stage 908). The third mold layer is then patterned (stage 910). The first, second and third mold layers are sacrificial layers, similar to the sacrificial layers described above with respect to FIGS. 6B-6E and 7A-7D. As such, the term “mold layer” as used herein and the term “sacrificial layer” can be used interchangeably with respect to this application. A structural layer is then deposited on the exposed surfaces of the mold (stage 912). The structural layer is then patterned to form shutter assemblies having anchors, electrostatic actuators and shutters having at least one protrusion that can have a depth substantially different from the height of corresponding electrostatic actuators (stage 914). Finally, the structure including the shutter assembly is released from the mold (stage 916). Further aspects of the manufacturing process are described below in relation to FIGS. 10A-10F and FIGS. 11A-11D.

FIGS. 10A-10F show stages of construction of an example display apparatus, such as the display apparatus 800 shown in FIG. 8. The depicted process yields the shutter assembly 810 shown in FIG. 8. The process begins, as shown in FIG. 10A, with the deposition of a first mold layer 1002 over the substrate 802 (stage 901). Example materials for the first mold layer 1002 are provided above in the discussion of FIGS. 6A-6E. The first mold layer 1002 is then patterned to create recesses 1004 within which the anchors 812 supporting the electrostatic actuators 820 eventually will be formed (stage 902). The dimensions of the recesses 1004 will determine the shape of the base of the anchors 812. The thickness of the first mold layer 1002 can determine the distance between the bottom of the actuators 820 and the surface of the substrate 802. The deposition and patterning of the first sacrificial material 1002 is similar in concept, and uses similar materials and techniques, as those described for the deposition and patterning described in relation to, for example, FIGS. 6B and 7A.

As shown in FIG. 10B, the process continues with the deposition of a second mold layer 1012 over the first mold layer 1002 (stage 904). Example materials for the second mold layer 1012 are provided above in the discussion of FIGS. 6A-6E. The second mold layer 1012 is deposited on the exposed surfaces of the first mold layer 1002. The second mold layer 1012 can have the same or different material composition as the first mold layer 1002.

As shown in FIG. 10C, the second mold layer 1012 is then patterned to recreate the recesses 1004 corresponding to the base portion of the anchors 812 (stage 906). In addition, the second mold layer 1012 is patterned to form a mesa 1014 on which the distal portion 852 of the shutter protrusion 850, as depicted in FIG. 8, will be formed (stage 906). The height of the mesa 1014, which corresponds to the thickness of the second mold layer 1012, together with the thickness of the first mold layer 1002, correspond to the distance between the distal surface 852 of the protrusion 850 and the surface of the substrate 802. The deposition and patterning of the second mold layer 1012 is similar in concept, and uses similar materials and techniques, as those described for the deposition and patterning described in relation to, for example, FIGS. 6B and 7B.

As shown in FIG. 10D, the process continues with the deposition of a third mold layer 1022 over exposed surfaces of the second mold layer 1012 (stage 908). The third mold layer 1022 can be formed from the same materials used to form the first and second mold layers 1002 and 1012 or any other suitable sacrificial material described above. Then, as shown in FIG. 10E, the third mold layer 1022 is patterned to form recesses 1024 that correspond to regions where the shutter protrusion 850 will be formed, recesses 1026 that correspond to regions where the actuators 820 will be formed and recesses 1028 that correspond to regions where the anchors 804 will be formed (stage 910). The deposition and patterning of the third sacrificial material 1022 is similar in concept, and uses similar materials and techniques, as those described for the deposition and patterning described in relation to, for example, FIGS. 6B and 7B.

A stack of materials 1032 (or stack 1032), including at least one layer of conductive material, is deposited on the exposed surfaces of the mold layers 852, 856, and 860 (stage 912). Example materials for the stack of materials 1032 are provided above in the discussion of FIGS. 6C and 7C. As shown in FIG. 10F, the stack 1032 is then patterned to form the various components of the display element, including the anchors 804, the actuators 820 and the shutters 840 (stage 914). In some implementations, the stack 1032 is patterned to allow selective removal of portions of the stack 1032 by applying an anisotropic etch resulting in the structures depicted in FIG. 8. Once the four-stage masking process is completed, the mold is removed, thereby releasing the anchors 804, the actuators 820 and the shutters 840 such that the shutters 840 are supported by corresponding actuators 820, which in turn are supported by the anchors 804 over the underlying substrate 802 (stage 916). The deposition and patterning of the structural material 1032 is similar in concept, and uses similar materials and techniques, as those described for the deposition and patterning of the shutter material described in relation to, for example, FIGS. 6C and 7C.

As described above with respect to FIG. 10E, when forming the actuators 820, the third mold layer 1022 is patterned such that the recesses 1026 within which the actuators 820 eventually will be formed are deep enough to expose the first mold layer 1002. In some other implementations, the actuators 820 can be formed by first patterning the second mold layer 1012 to form recesses, and then depositing and patterning the third mold layer 1022 to form recesses that are aligned with the recesses formed in the second mold layer 1012. As such, the portion of the mold used to form the actuators 820 includes both the second mold layer 1012 and the third mold layer 1022. Additional details related to forming the shutter assembly 810 in such a manner is described below with respect to FIGS. 11A-11D.

FIGS. 11A-11D show stages of construction of an example display apparatus, such as the display apparatus 800 shown in FIG. 8. FIG. 11A shows the resulting mold after patterning a second mold layer 1112 (stage 906). In some implementations, such as the implementation shown in FIG. 11A, the second mold layer 1112 is patterned to form wider recesses 1114 in the second mold layer 1112, while recreating the recesses 1104 (shown in FIG. 10A) that were formed during the patterning of a first mold layer 1102. The wider recesses 1114 and the recesses 1104 correspond to the regions where the anchors 812 will eventually be formed. In addition, the second mold layer 1112 is patterned to form recesses 1116 that correspond to regions where the actuators 820a and 820b will be formed. Additional remaining sacrificial material of the second mold layer 1112 forms a mesa 1114 on which the distal portion 852 of the shutter protrusion 850, as depicted in FIG. 8, will be formed. In some implementations, the mesa 1114 is substantially identical to the mesa 1014 shown in FIG. 10C. As described above, the height of the mesa 1114, which corresponds to the thickness of the second mold layer 1112, together with the thickness of the first mold layer 1102, correspond to the distance between the distal surface 852 of the protrusion 850 and the surface of the substrate 802.

As shown in FIG. 11B, the process continues with the deposition of a third mold layer 1122 over exposed surfaces of the second mold layer 1112 (stage 908). The third mold layer 1122 can have the same or different material composition as the materials used to form the first mold layer 1102 and/or the second mold layer 1112.

Then, as shown in FIG. 11C, the third mold layer 1122 is patterned to form recesses 1124 that correspond to regions where the shutter protrusion 850 will be formed, recesses 1126 that correspond to regions where the actuators 820 will be formed and recesses 1128 that correspond to regions where the anchors 804 will be formed (stage 910). The creation of the recesses 1126 and 1128 includes recreating the recesses 1116 and 1114 respectively, in the second mold layer and the recesses 1104 in the first mold layer 1102. In some such implementations, the recesses 1126 are aligned with the corresponding recesses 1116 and the recesses 1128 are aligned with the recesses 1114.

A stack of materials 1132 (or stack 1132), including at least one layer of conductive material, is deposited on the exposed surfaces of the mold layers 1002, 1112, and 1122 (stage 912). Similar to as shown in FIG. 10F, the stack 1132 is then patterned to form the various components of the display element, including the anchors 804, the actuators 820 and the shutters 840 (stage 914). In some implementations, the stack 1132 is patterned to allow selective removal of portions of the stack 1132 by applying an anisotropic etch resulting in the structures depicted in FIG. 8. Once the four-stage masking process is completed, the mold is removed, thereby releasing the anchors 804, the actuators 820 and the shutters 840 such that the shutters 840 are supported by corresponding actuators 820, which in turn are supported by the anchors 804 over the underlying substrate 802 (stage 916).

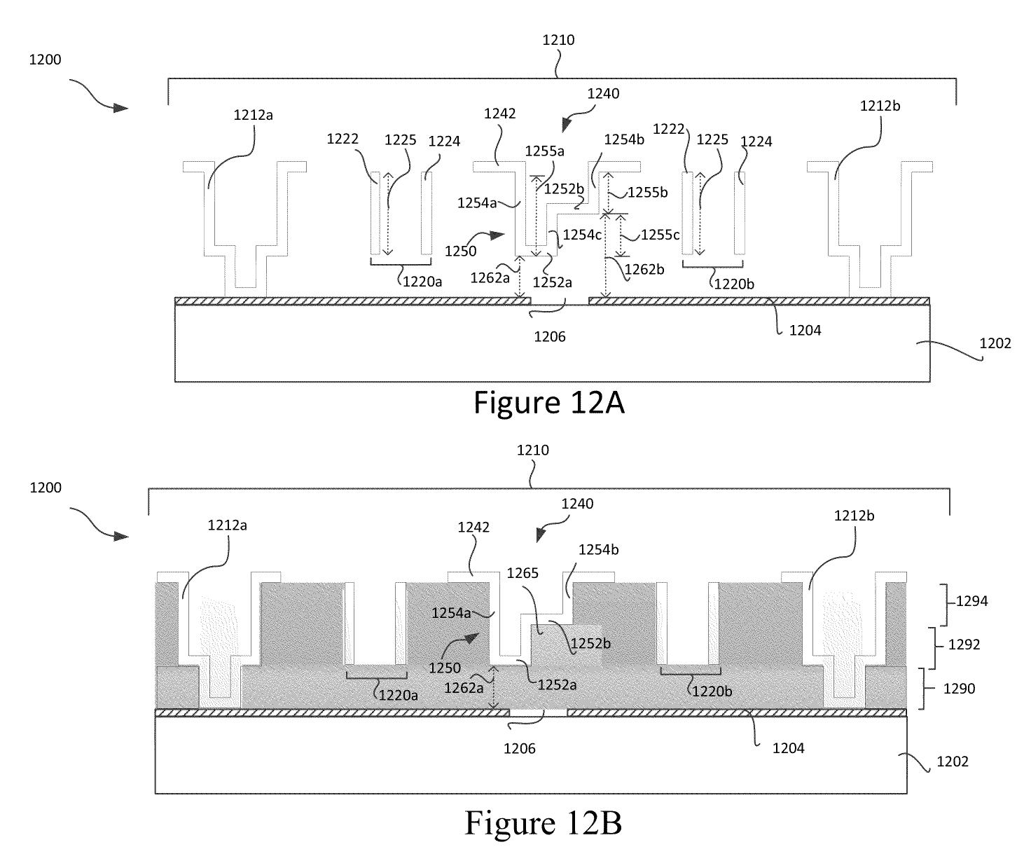

By forming shutter assemblies using three mold layers, display structures having stepped shutters can be formed. FIGS. 12A and 12B show one such example display structure.

FIG. 12A shows a cross-sectional view of a portion of another example EMS shutter-based display apparatus 1200. The display apparatus 1200 is similar to the display apparatus 800 shown in FIG. 8 in that the display apparatus 1200 includes a shutter 1240 that has a sidewall 1254b of a shutter protrusion 1250, which has a height 1255b that is substantially different than a height 1225 of a corresponding pair of electrostatic actuators 1220a and 1220b (generally referred to as actuators 1220).

A shutter assembly 1210 is formed on a substrate 1202 having a light blocking layer 1204 through which an aperture 1206 is formed. The shutter assembly 1210 includes anchors 1212a and 1212b that are configured to support the pair of electrostatic actuators 1220a and 1220b and the shutter 1240. The actuators 1220 are responsible for moving the shutter 1240 between states. The electrostatic actuator 1220a is configured to drive the shutter 1240 in a first direction, while the electrostatic actuator 1220b is configured to drive the shutter 1240 in a second direction, opposite the first direction. Each of the actuators 1220 includes a drive beam electrode 1222 and a load beam electrode 1224 positioned opposite the drive beam electrode 1222. The load beam electrodes 1224 of the first and second actuators 1220 are connected to the shutter 1240 and are responsive to a drive voltage applied to a corresponding drive electrode 1222. The electrostatic actuators 1220 have a height 1225 that corresponds to the heights of the drive electrodes 1222 and the load electrodes 1224.

The shutter 1240 includes a primary planar portion 1242 that extends substantially parallel to the substrate 1202. The shutter 1240 also includes at least one protrusion 1250. In contrast to the protrusion 850 shown in FIG. 8, the protrusion 1250 includes a step. In particular, the shutter 1240 includes a protrusion 1250 that is defined by first and second distal portions 1252a and 1252b that are substantially parallel to the primary planar surface 1242, three sidewalls 1254a-1254c and a pair of end walls that connect to the sidewalls 1254a-1254c at both ends. One sidewall 1254a has a height 1255a substantially equal to the height of the actuators 1220, and two shorter sidewalls 1254b and 1254c have corresponding heights 1255b and 1255c that are substantially shorter than the height of the actuators 1255. Due to the step formed in the protrusion 1250, the first distal portion 1252a of the shutter 1240 is separated from the underlying substrate 1202 by a distance 1262a, while the second distal portion 1252b of the shutter 1240 is separated from the underlying substrate by a larger distance 1262b.

A stepped-protrusion shutter, such as the shutter 1240, can provide improved light trapping capabilities than a shallow-protrusion shutter. This is because the light entering a deeper portion of the stepped-protrusion is more likely to rebound off multiple surfaces before escaping the protrusion. Some fraction of the light is absorbed by the surface of the shutter with each reflection. A shutter having such a configuration also allows the shutter to be driven differently towards one side in comparison to the other side. This is because the configuration of the sidewall 1254a is different from the configuration of the sidewalls 1254b and 1254c on the opposite side of the protrusion 1250. In particular, when the shutter 1240 is driven towards the actuator 1220a, the larger sidewall 1254a is forcing fluid away from the path of the shutter 1240. In contrast, when the shutter 1240 is driven towards the actuator 1220b, the sidewalls 1254b and 1254c are forcing fluid away from the path of the shutter 1240.

FIG. 12B shows the example display apparatus 1200 prior to be released from a corresponding mold. The mold is substantially similar to the mold used to form the display apparatus 800 shown in FIG. 10F in that the mold also includes a first mold layer 1290, a second mold layer 1292 and a third mold layer 1294. Each of the mold layers 1290, 1292 and 1294 are patterned such that a structure corresponding to the display apparatus 1200 is formed. In particular, the second mold layer 1292 is patterned to form a mesa 1265 on which the second distal portion 1252b is eventually formed. The thickness of the first mold layer 1290 defines the distance 1262a between the first distal portion 1252a and the substrate 1202 as well as the distance between the bottom surface of the actuators 1220 and the substrate 1202. The thickness of the second mold layer 1292 defines the height of the step, which corresponds to the height of the third sidewall 1254c that connects the first distal portion 1252a and the second distal portion 1252b. The thickness of the second mold layer 1292 and the third mold layer 1294 define the height of the actuators 1220.

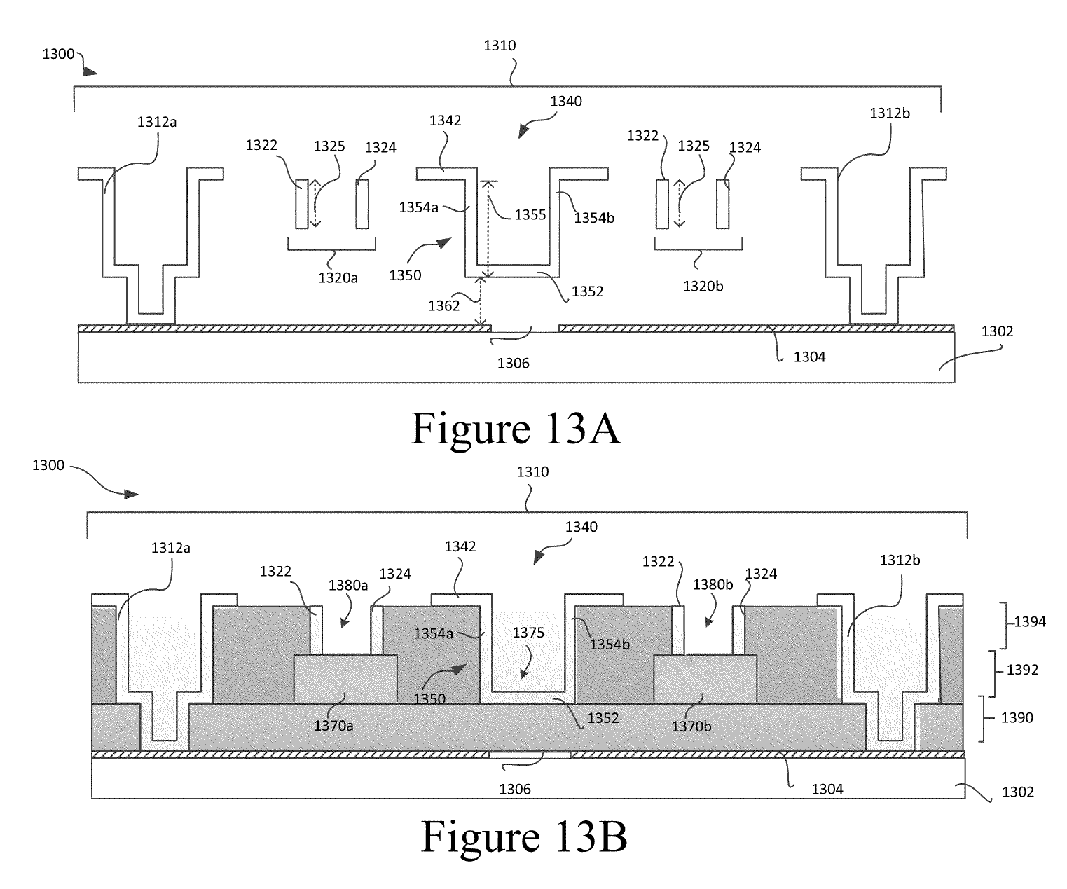

FIG. 13A shows a portion of an EMS shutter-based display apparatus 1300. The display apparatus 1300 is similar to the display apparatus 800 shown in FIG. 8 in that the display apparatus 1300 includes a shutter 1340 that has a protrusion 1350 defined by two sidewalls 1354a and 1354b that have heights 1355 that are substantially different than a height 1325 of a corresponding pair of electrostatic actuators 1320a and 1320b (generally referred to as actuators 1320).

A shutter assembly 1310 is formed on a substrate 1302 having a light blocking layer 1304 through which an aperture 1306 is formed. The shutter assembly 1310 includes anchors 1312a and 1312b that are configured to support the pair of electrostatic actuators 1320a and 1320b and the shutter 1340. The actuators 1320 are responsible for moving the shutter 1340 between states. The electrostatic actuator 1320a is configured to drive the shutter 1340 in a first direction, while the electrostatic actuator 1320b is configured to drive the shutter 1340 in a second direction, opposite the first direction. Each of the actuators 1320 includes a drive beam electrode 1322 and a load beam electrode 1324. The load beam electrodes 1324 of the first and second actuators 1320 are connected to the shutter 1340 and are responsive to a drive voltage applied to a corresponding drive electrode 1322. The height 1325 of the electrostatic actuators 1320 corresponds to the heights of the drive electrodes 1322 and the load electrodes 1324.

The shutter 1340 includes a primary planar portion 1342 that extends substantially parallel to the substrate 1302. The shutter 1340 also includes at least one protrusion 1350. The protrusion 1350 is defined by the two sidewalls 1354a and 1354b (generally referred to as sidewalls 1354), a pair of end walls that connect to the sidewalls 1354a and 1354b at both ends and a distal portion 1352 that is parallel to the primary planar portion 1342. The heights 1355 (generally referred to as sidewall height 1355) of the first sidewall 1354a and the second sidewall 1354b correspond to the depth of the protrusion 1350. The sidewall heights 1355 of the sidewalls 1354a and 1354b are substantially taller than the height 1325 of the actuators 1320a and 1320b. In particular, the top surfaces of the actuators 1320 are substantially aligned with the top surface of the primary planar portion 1342, while the bottom surfaces of the actuators 1320, i.e. the surfaces facing the substrate 1302 are farther away from the substrate 1302 than the bottom surface of the distal portion 1352. Stated in another way, the configuration of the shutter assembly 1310 depicted in FIG. 13A illustrates a shutter 1340 having a protrusion 1350 which is deeper than the actuators 1320a and 1320b are tall. Due to the deeper protrusion 1350, the distal portion 1352 of the shutter 1340 is separated from the underlying substrate 1302 by a relative small distance 1362 compared to the distance 862 between the distal portion 852 and the corresponding substrate 802 shown in FIG. 8. A deeper-protrusion shutter, such as the shutter 1340, allows for improved light trapping capabilities since the light entering a deeper protrusion is more likely to rebound off multiple surfaces before escaping the protrusion. Some fraction of the light is absorbed by the surface of the shutter with each reflection.

FIG. 13B shows the example display apparatus 1300 prior to be released from a corresponding mold. The mold is similar to the mold used to form the display apparatus 800 shown in FIG. 10F in that the mold also includes a first mold layer 1390, a second mold layer 1392 and a third mold layer 1394. Each of the mold layers 1390, 1392 and 1394 are patterned such that a structure corresponding to the display apparatus 1300 is formed. In particular, the second mold layer 1392 is patterned to form two mesas 1370a and 1370b on which the actuators 1320a and 1320b eventually will be formed. The third mold layer 1394 is patterned to form the recesses 1380a and 1380b within which the actuators 1320a and 1320b eventually will be formed. Further, the third mold layer 1394 is patterned to also form an recess 1375 within which the protrusion 1350 of the shutter 1340 eventually will be formed. The recess 1375 extends to a top surface of the first mold layer 1390. The thickness of the first mold layer 1390 defines the distance 1362 between the distal portion 1352 and the substrate 1202, while the thickness of the first mold layer 1390 and the second mold layer 1392 defines the distance between the bottom surface of the actuators 1320 and the substrate 1302. The height 1325 of the actuators 1320 is defined by the thickness of the third mold layer 1394, while the height 1355 of the sidewalls 1354a and 1254 of the shutter 1340 are defined by the thicknesses of the second mold layer 1392 and the third mold layer 1394.

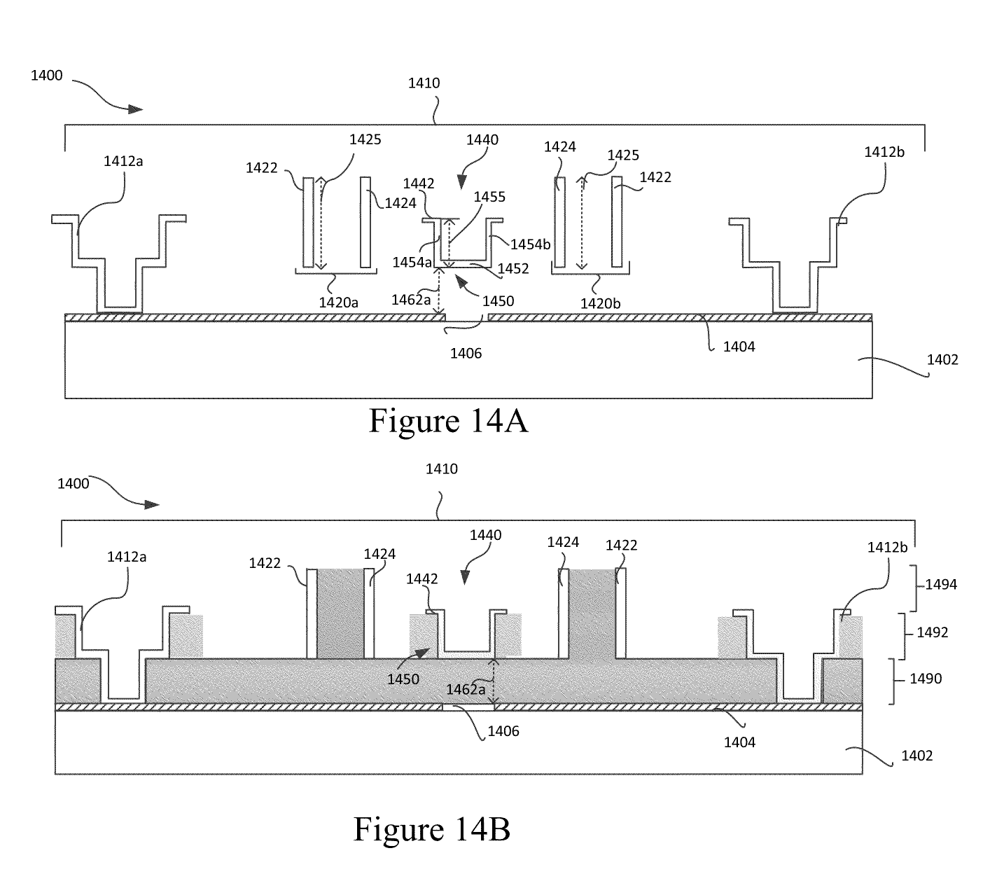

FIG. 14A shows a cross-sectional view of a portion of another example EMS shutter-based display apparatus 1400. The display apparatus 1400 is similar to the display apparatus 800 shown in FIG. 8 in that the display apparatus 1400 includes a shutter 1440 that has a protrusion 1450 defined by two sidewalls 1454a and 1454b that have heights 1455 that are substantially different than a height 1425 of a corresponding pair of electrostatic actuators 1420a and 1420b (generally referred to as actuators 1420).

A shutter assembly 1410 is formed on a substrate 1402 having a light blocking layer 1404 through which an aperture 1406 is formed. The shutter assembly 1410 includes anchors 1412a and 1412b (generally referred to as anchors 1412) formed on the substrate 1402 that are configured to support the electrostatic actuators 1420a and 1420b and the shutter 1440. The actuators 1420 are responsible for moving the shutter 1440 between states. The electrostatic actuator 1420a is configured to drive the shutter 1440 in a first direction, while the electrostatic actuator 1420b is configured to drive the shutter 1440 in a second direction, opposite the first direction. Each of the actuators 1420 includes a drive beam electrode 1422 and a load beam electrode 1424 opposite the drive beam electrode 1422. The load beam electrodes 1424 of the first and second actuators 1420 are connected to the shutter 1440 and are responsive to a drive voltage applied to a corresponding drive electrode 1422. The height 1425 of the electrostatic actuators 1420 corresponds to the heights of the drive electrodes 1422 and the load electrodes 1424.

The shutter 1440 includes a primary planar portion 1442 that extends substantially parallel to the substrate 1402. The shutter 1440 also includes at least one protrusion 1450. The protrusion 1450 is defined by the two sidewalls 1454a and 1454b (generally referred to as sidewalls 1454), a pair of end walls that connect to the sidewalls 1454a and 1454b at both ends and a distal portion 1452 that is parallel to the primary planar portion 1442. The heights 1455 (generally referred to as sidewall height 1455) of the first sidewall 1454a and the second sidewall 1454b correspond to the depth of the protrusion 1450. The sidewall heights 1455 of the sidewalls 1454a and 1454b are substantially shorter than the height 1425 of the actuators 1420a and 1420b. As such, similar to the shutter assembly 810 shown in FIG. 8, the configuration of the shutter assembly 1410 depicted in FIG. 14A illustrates a shutter 1440 having a protrusion 1450 which is shallower than the actuators 1420a and 1420b. However, in contrast to the shutter assembly 800 shown in FIG. 8, the bottom surfaces of the actuators 1420 facing the substrate 1402 are substantially aligned with the bottom surface of the distal portion 1452, while the top surface of the actuators 1420 facing away from the substrate 1402 is farther away from the substrate 1402 than the top surface of the primary planar portion 1442. Due to the shallower protrusion 1450, the shutter 1440 may have a faster speed through a fluid in which the shutter 1440 is immersed within the display.

FIG. 14B shows the example display apparatus 1400 prior to be released from a corresponding mold. The mold is substantially similar to the mold used to form the display apparatus 800 shown in FIG. 10F in that the mold also includes a first mold layer 1490, a second mold layer 1492 and a third mold layer 1494. Each of the mold layers 1490, 1492 and 1494 are patterned such that a structure corresponding to the display apparatus 1400 is formed. In particular, the second mold layer 1492 is patterned to form recesses where the anchors eventually will be formed as well as an recess in which the shutter 1440 eventually will be formed. The thickness of the first mold layer 1490 defines the distance 1462 between the distal portion 1452 and the substrate 1402 as well as the distance between the bottom surface of the actuators 1420 and the substrate 1402. The thickness of the second mold layer 1492 defines the height of the sidewalls 1454a and 1454b of the shutter 1440. The thickness of the second mold layer 1492 and the third mold layer 1494 defines the height of the actuators 1420.

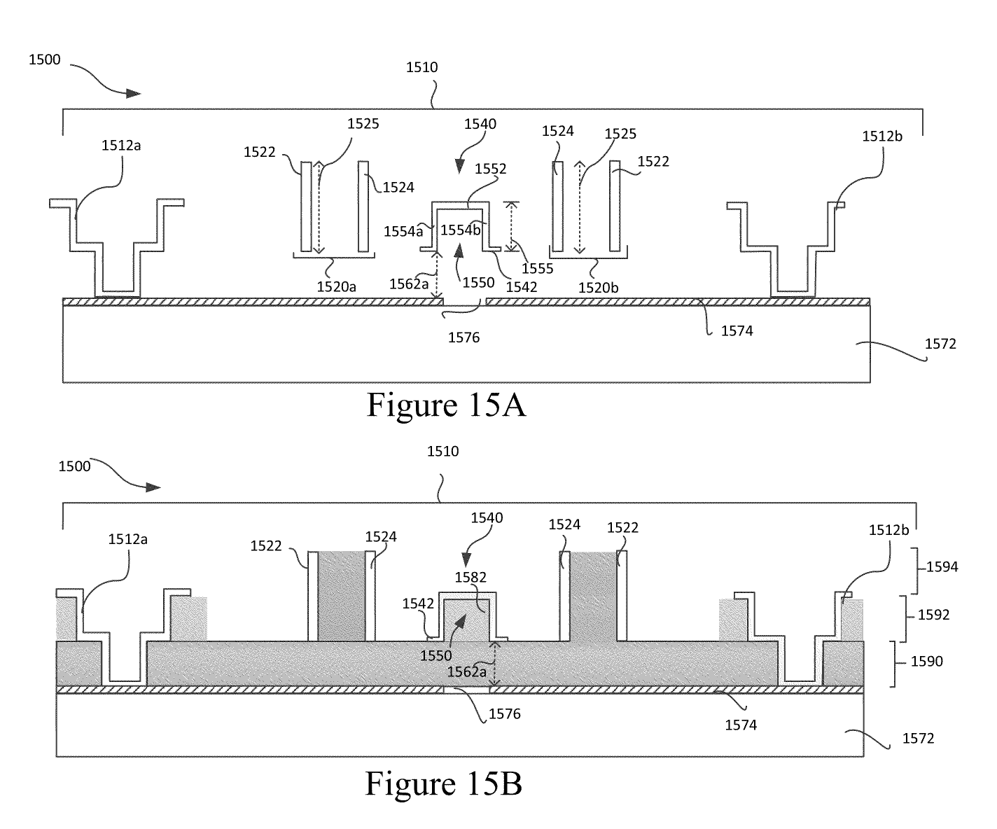

FIG. 15A shows a cross-sectional view of a portion of another example EMS shutter-based display apparatus 1500. The display apparatus 1500 is similar to the display apparatus 1400 shown in FIGS. 14A and 14B in that the display apparatus 1500 includes a shutter 1540 that has a protrusion 1550 defined by two sidewalls 1554a and 1554b that have heights 1555 that are substantially shorter than a height 1525 of a corresponding pair of electrostatic actuators 1520a and 1520b (generally referred to as actuators 1520). A shutter assembly 1510 is formed on a substrate 1572 having a light blocking layer 1574 through which an aperture 1576 is formed. The display apparatus 1500 corresponds to a MEMS up configuration, in which the display apparatus 1500 includes a shutter assembly 1510 that is formed on a front-facing surface of a substrate 1572 positioned adjacent a backlight. This is in contrast to the display apparatus 1400 shown in FIGS. 14A and 14B, which corresponds to a MEMS-down configuration, in which the shutter assembly 1410 is formed on a rear surface of a substrate 1572 that forms a front portion of the display apparatus 1400.

Referring still to FIG. 15A, the shutter assembly 1510 includes anchors 1512a and 1512b (generally referred to as anchors 1512) formed on the substrate 1572 that are configured to support the electrostatic actuators 1520a and 1520b and the shutter 1540. The actuators 1520 are responsible for moving the shutter 1540 between states. The electrostatic actuator 1520a is configured to drive the shutter 1540 in a first direction, while the electrostatic actuator 1520b is configured to drive the shutter 1540 in a second direction, opposite the first direction. Each of the actuators 1520 includes a drive beam electrode 1522 and a load beam electrode 1524 opposite the drive beam electrode 1522. The load beam electrodes 1524 of the first and second actuators 1520 are connected to the shutter 1540 and are responsive to a drive voltage applied to a corresponding drive electrode 1522. The height 1525 of the electrostatic actuators 1520 corresponds to the heights of the drive electrodes 1522 and the load electrodes 1524.

The shutter 1540 includes a primary planar portion 1542 that extends substantially parallel to the substrate 1502. The shutter 1540 also includes at least one protrusion 1550. The protrusion 1550 is defined by the two sidewalls 1554a and 1554b (generally referred to as sidewalls 1554), a pair of end walls that connect to the sidewalls 1554a and 1554b at both ends and a distal portion 1552 that is parallel to the primary planar portion 1542. The heights 1555 (generally referred to as sidewall height 1555) of the first sidewall 1554a and the second sidewall 1554b correspond to the depth of the protrusion 1550. The sidewall heights 1555 of the sidewalls 1554a and 1554b are substantially shorter than the height 1525 of the actuators 1520a and 1520b. As such, similar to the shutter assembly 1410 shown in FIGS. 14A and 14B, the configuration of the shutter assembly 1510 depicted in FIG. 15A illustrates a shutter 1540 having a protrusion 1550 which is shallower than the actuators 1520a and 1520b. However, in contrast to the shutter assembly 1400 shown in FIGS. 14A and 14B, the bottom surfaces (proximal end) of the actuators 1520 facing the substrate 1502 are substantially aligned with the top surface of the primary planar portion 1542, while the top surfaces (distal end) of the actuators 1520 facing away from the substrate 1502 is farther away from the substrate 1502 than the bottom surface of the distal portion 1552. Due to the shallower protrusion 1550, the shutter 1540 may have a faster speed through a fluid in which the shutter 1540 is immersed within the display. In addition, due to the reduced distance between the primary planar portion 1542 and the aperture 1506, the display apparatus 1500 can provide better light blocking capabilities.

FIG. 15B shows the example display apparatus 1500 prior to being released from a corresponding mold. The mold is substantially similar to the mold used to form the display apparatus 800 shown in FIG. 10F in that the mold also includes a first mold layer 1590, a second mold layer 1592 and a third mold layer 1594. Each of the mold layers 1590, 1592 and 1594 are patterned such that a structure corresponding to the display apparatus 1500 is formed. In particular, the second mold layer 1592 is patterned to form recesses where the anchors eventually will be formed as well as an mesa 1582 over which the shutter 1540 eventually will be formed. The thickness of the first mold layer 1590 defines the distance 1562 between the primary planar portion 1542 and the substrate 1502 as well as the distance between the bottom surface of the actuators 1520 and the substrate 1502. The thickness of the second mold layer 1592 defines the height of the sidewalls 1554a and 1554b of the shutter 1540. The thickness of the second mold layer 1592 and the third mold layer 1594 defines the height of the actuators 1520.

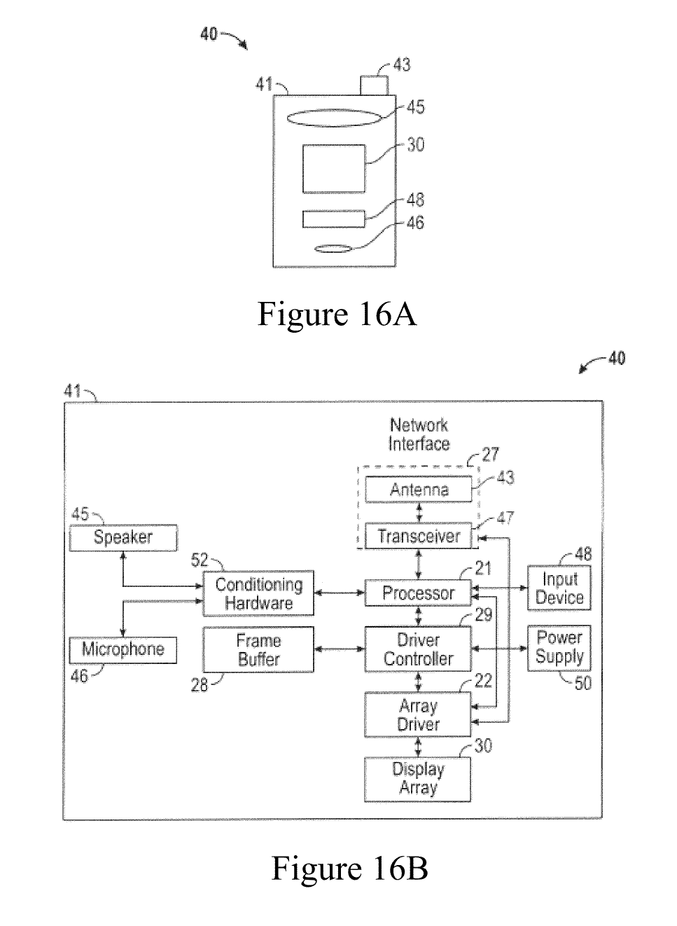

FIGS. 16A and 16B are system block diagrams illustrating a display device 40 that includes a set of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device.

The components of the display device 40 are schematically illustrated in FIG. 16B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 16B, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller. Additionally, the array driver 22 can be a conventional driver or a bi-stable display driver. Moreover, the display array 30 can be a conventional display array or a bi-stable display array. In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus, comprising:
an electrostatic actuator including opposing beam electrodes having primary faces normal to a substrate on which they are formed, wherein the height of at least one of the opposing beam electrodes defines an actuator height; and
an electromechanical system (EMS) shutter configured to be driven by the electrostatic actuator, the shutter including at least one protrusion, the protrusion having a first sidewall and a second sidewall normal to a primary plane of the shutter, wherein a distal end of the actuator extends beyond a distal end of the first sidewall relative to the substrate.

2. The apparatus of claim 1, wherein an actuator height of the actuator is substantially similar to a second sidewall height of the second sidewall.

3. The apparatus of claim 1, wherein an actuator height of the actuator is substantially larger than a first sidewall height of the first sidewall and a second sidewall height of the second sidewall.

4. The apparatus of claim 1, wherein the protrusion includes a first distal surface parallel to the primary plane that is adjacent to a first sidewall and a second distal surface parallel to the primary plane adjacent to a second sidewall, wherein a height of the first sidewall is substantially different from a corresponding height of the second sidewall.

5. The apparatus of claim 1, wherein the protrusion includes a distal surface parallel to the primary plane, wherein the actuator has a proximal end aligned with the distal surface.

6. The apparatus of claim 1, wherein the primary plane is aligned with the distal end of the actuator.

7. The apparatus of claim 1, wherein the opposing beam electrodes includes a drive electrode and a load electrode, the load electrode having a height substantially smaller than the drive electrode.

8. The apparatus of claim 1, further comprising:
a display;
a processor that is configured to communicate with the display, the processor being configured to process image data; and
a memory device that is configured to communicate with the processor.

9. The apparatus of claim 8, further comprising:
a driver circuit configured to send at least one signal to the apparatus; and
a controller configured to send at least a portion of the image data to the driver circuit.

10. The apparatus of claim 8, further comprising:
an image source module configured to send the image data to the processor, wherein the image source module comprises at least one of a receiver, transceiver, and transmitter.

11. The apparatus of claim 8, further comprising:
an input device configured to receive input data and to communicate the input data to the processor.

12. A method of fabricating a display structure, comprising:
depositing a first mold layer over a substrate;
patterning the deposited first mold layer;
depositing a second mold layer over the patterned first mold layer;
patterning the deposited second mold layer to form anchors openings corresponding to where anchors will eventually be formed;
depositing a third mold layer over the patterned second mold layer;
patterning the deposited third mold layer to form protrusion openings corresponding to where a protrusion of a shutter of the display structure will eventually be formed, and to form actuator openings corresponding to where actuator beams of an actuator of the display structure will eventually be formed;
depositing electrically conductive material over the patterned third mold layer; and
patterning the electrically conductive material to form the actuator and the shutter having the protrusion, the actuator having a height that is substantially different from a height of one of the sidewalls of the protrusion.

13. The method of claim 12, further comprising releasing the display structure including the actuator and the shutter.

14. The method of claim 12, wherein patterning the deposited third mold layer comprises forming actuator openings that extend to a top surface of the first mold layer.

15. The method of claim 14, wherein patterning the deposited third mold layer comprises forming a protrusion opening that extends to a top surface of the second mold layer.

16. The method of claim 12, wherein patterning the deposited third mold layer comprises forming a protrusion opening that extends to a top surface of the second mold layer and to a top surface of the first mold layer such that a bottom of the opening is defined by both the first mold layer and the second mold layer.

17. The method of claim 12, wherein patterning the deposited third mold layer comprises forming actuator openings that extend to a top surface of the second mold layer.

18. The method of claim 17, wherein patterning the deposited third mold layer comprises forming a protrusion opening that extends to a top surface of the first mold layer.
